(19) United States
(12) Patent Application Publication
(10) Pub. No.: US 2025/0198890 A1
(43) Pub. Date: Jun. 19, 2025

(54) Method and Apparatus for Separating and Concentrating Analytes

(71) Applicant: BuzzKill Labs, Inc., Livermore, CA (US)

(72) Inventors: Katrina Marie MYERS, Livermore, CA (US); George FARQUAR, Livermore, CA (US); Marcus TOFANELLI, Livermore, CA (US)

(21) Appl. No.: 18/847,242

(22) PCT Filed: Mar. 15, 2023
(86) PCT No.: PCT/US2023/015329

§ 371 Date: Sep. 14, 2024

Related U.S. Application Data
(60) Provisional application No. 63/320,208, filed on Mar. 15, 2022.

(51) Int. Cl. G01N 1/40; B01D 15/10

(52) U.S. Cl. CPC G01N 1/4005; B01D 15/10

(57) ABSTRACT

Articles, systems, and methods for quickly testing for and precisely quantifying a dilute analyte in a sample, e.g., a drug in a biological sample, include a substrate at least partially coated with chromatography medium reservoirs configured to deliver solvent to the chromatography medium, and a detector configured to detect the analyte. Additionally provided are methods for quantifying the amount of the dilute analyte in the mixture. Methods can include separating molecules in a sample in a first dimension chromatographically, and then concentrating an analyte in a second dimension chromatographically.

### REFERENCE TO RELATED APPLICATIONS

This application claims the benefit of the priority date of U.S. Provisional Application 63/320,208, filed Mar. 15, 2022, the contents of which are incorporated herein in their entirety.

### STATEMENT AS TO FEDERALLY SPONSORED RESEARCH

None.

### THE NAMES OF THE PARTIES TO A JOINT RESEARCH AGREEMENT

None.

### SEQUENCE LISTING

None.

### BACKGROUND

According to an April 2017 poll, approximately 22% of American adults, or ˜54.5 million people, currently use marijuana, with 63% of this group indicating regular use. There are thus nearly as many marijuana users as there are cigarette smokers (˜59 million cigarette smokers). This number is expected to increase as marijuana legalization becomes more common. Additionally, the Department of Justice reports that the overall availability of controlled prescription and illegal drugs in the U.S. is also increasing or remaining stable at high rates. In a 2017 National Drug Threat report, the DEA noted that more individuals report current use of controlled prescription drugs than for cocaine, heroin, and methamphetamine combined, making controlled prescription drug use second only to marijuana.

As a result of increased drug usage, there are more drug-impaired drivers on the road than ever before. Indeed, drivers in fatal crashes are now more likely to be under the influence of drugs than alcohol. In Colorado, one of the first states to legalize recreational marijuana (2012), a November 2017 survey conducted by the Colorado Department of Transportation found that 55% of marijuana users believed it is safe to drive while under the influence. However, studies show that under the influence of THC, the psychoactive compound in marijuana, a user's reaction time and perception of distance and speed are both impaired.

There is currently not an efficient and reliable quantitative portable test for marijuana and other drug use. In particular, it is currently very difficult to enforce Driving Under the Influence of Drug (DUID) laws with existing oral fluid (i.e., saliva), breath, and blood tests. The lack of adequate roadside drug testing and effective DUID enforcement can result in a larger number of serious and/or fatal accidents. The current testing method requires that a Drug Recognition Expert (DRE) be called to the scene to perform a standard 12-step evaluation for impairment. Based upon the results of the DRE evaluation, the officer can determine whether probable cause has been established and arrest the driver. Once arrested and transported to the station, blood tests can be performed, and the results sent to the lab for evidentiary purposes. However, the use of Drug Recognition Experts (DREs) to establish probable cause is inefficient because: (a) it requires a trained expert, usually in addition to the detaining officer, doubling the manpower necessary, (b) it takes time for the expert to get to the scene once called, allowing drug levels to drop as drugs are metabolized, and (c) the DRE's subjective assessment still usually requires scientific evidence of drug presence through urinalysis or blood analysis by toxicologists to prosecute. Moreover, blood drawn hours later is not representative of the level of drugs present at the time of the traffic stop. Unlike alcohol, where the elimination rate is well understood, THC and other drug elimination rates are not consistent. Toxicologists therefore cannot perform retrograde extrapolation to estimate the amount of drugs present in a person's blood at a specific time in the past.

In addition to roadside testing, there has been a corresponding increase in need for drug testing in the workplace, police stations, hospitals, and other locations. The most common method currently used for workplace drug testing, for example, requires a urine sample to be collected and sent off to a lab. The sample is then sealed sent to a laboratory for analysis. The resulting test results are then sent to the employer. The results have two significant problems for employers. First, there is often extensive time delay from sample to the results. Second, urine does not accurately reflect the current level of drugs in a person's system. Rather, urine indicates the level of drugs in person at the time the urine was collected in the bladder. If an individual had a full bladder and proceeded to consume marijuana or other drugs, the levels of drugs in the urine would not increase until the bladder was emptied and refiled, yielding a false negative. Similar urine tests are often used in police stations and other medical settings. Accordingly, employers, emergency room workers, and others need a system to rapidly identify the concentration in near real time to aid in identifying if an employee is fit to continue work or to access the concentration of chemical in the sample. The current methods take time for sample transport and require a skilled worker and traditional laboratory equipment. Furthermore, drugs can be present at a dilute concentration in the sample, therefore a need to either concentrate or load a significant volume of the sample is needed.

Accordingly, an efficient and reliable quantitative test for dilute amounts of an analyte, e.g., marijuana and other drugs, in a sample is desired.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1A shows an exemplary article and method for analysis of one or more dilute analytes in a sample comprising applying a concentrating solvent to one side of the second dimension.

FIG. 1B shows an exemplary article and method for analysis of one or more dilute analytes in a sample comprising applying a concentrating solvent to both sides of the second dimension.

FIG. 2A shows an exemplary article and method for analysis of one or more dilute analytes in a sample wherein the article further comprises a liquid barrier.

FIG. 2B shows an optional concentration step along the first dimension.

FIG. 3A shows an exemplary article and method for analysis of one or more dilute analytes in a sample wherein the article further comprises three fluidically disconnected areas.

FIG. 3B shows an optional concentration step along the first dimension.

FIG. 4A shows an exemplary article comprising multiple liquid barriers.

FIG. 4B shows an exemplary article comprising multiple liquid barriers.

FIG. 5 shows a sample concentration zone.

FIG. 6 shows an exemplary article and method concentrating a compound at the surface of the chromatography medium.

FIG. 7 shows an exemplary article comprising multiple regions with different properties.

FIG. 8 shows an exemplary article comprising a covering layer.

FIG. 9A shows exemplary articles comprising covering layers.

FIG. 9B shows exemplary articles comprising covering layers.

FIG. 10A shows an exemplary system comprising a heating element.

FIG. 10B shows concentration of an analyte.

FIG. 11 shows an exemplary method for detecting nanogram and sub-nanogram quantities of analyte comprising (A) sample loading step, (B) separation step, (C) first concentration step, (D) second concentration step, and (E) detection step.

FIG. 12 shows exemplary data for detecting nanogram quantities of analyte.

FIG. 13A shows a side profile of an exemplary fluid reservoir.

FIG. 13B shows an angled view of an exemplary fluid reservoir.

FIG. 13C shows fluid flowing from a fluid reservoir into chromatography medium.

FIG. 14 shows an exemplary article with multiple fluidic reservoirs.

### SUMMARY

Provided herein are articles, systems methods, and kits for performing thin layer chromatography (“TLC”). Methods involve a first round of performing chromatography in a first dimension and a second round of chromatography in the second dimension. Any number of additional rounds of chromatography can be performed in the first and/or second dimension as needed based on the application. In certain embodiments, methods include performing chromatography in a first dimension to separate analytes from non-analytes or contaminants, and in a second dimension to concentrate the analyte. Separation of one or more analytes in a mixture and subsequent concentration of analytes allow detection of analytes present in low levels in a sample with larger amounts of non-analytes by concentrating the analyte to concentrations detectable by suitable detection methods. In certain embodiments, a chromatography plate comprises gates and barriers, provided by removal of chromatography medium from the plate surface, positioned such that solvents can either transport separated analytes through gates, where medium remains, or prevent the passage of separated non-analytes past barriers, where medium is absent. The sample can comprise any suitable sample for analysis, for example biological samples, water samples, food samples, agricultural samples, industrial samples, research samples.

Provided herein is a method for separating, concentrating, and/or quantifying an analyte in a mixture, wherein the method comprises one or more of applying a sample to a TLC plate, separating the analyte from the mixture in a first dimension by applying a separating solvent, concentrating the analyte in a second dimension by applying a concentrating solvent to one or more sides of the analyte either sequentially or simultaneously, removing excess solvent, staining the analyte with an indicator, washing away excess indicator with a washing solvent, detecting the analyte, and quantifying the amount of analyte.

Provided herein is a method for separating, concentrating, and/or quantifying an analyte in a mixture, wherein the method comprises one or more of applying a sample to a TLC plate, concentrating the sample in a first and/or second dimension by applying a concentrating solvent to one or more sides of the first and/or second dimensions either sequentially or simultaneously, separating the analyte from the mixture in a first dimension by applying a separating solvent, concentrating the analyte in a second dimension by applying a concentrating solvent to one or more sides of the analyte either sequentially or simultaneously, removing excess solvent, staining the analyte with an indicator, washing away excess indicator with a washing solvent, detecting the analyte, and quantifying the amount of analyte.

Also provided are articles, such as chromatography plates, comprising partitions defined by spaces or areas from which medium is removed. Further provided are systems for performing chromatography.

### DETAILED DESCRIPTION

### I. Introduction

Disclosed herein are articles, systems, and methods for quickly testing for and precisely quantifying a dilute analyte in a sample, also referred to herein as a mixture, e.g., a drug in a biological sample. The articles, systems, and methods described herein can be performed in any setting with the required materials and can provide quantitative results for a variety of different compounds or substances of interest. The system can be configured to be used in the field for in situ testing or in an office or laboratory setting.

In certain embodiments, the sample comprises one or more analytes of interest. In certain embodiments, the sample can be any suitable sample, for example a biological sample, a water sample, a food sample, an agricultural sample, an industrial sample, a research sample, or any other suitable sample tentatively comprising an analyte of interest.

In certain embodiments, the sample comprises a biological sample, for example a sample sourced from a biological organism. In certain embodiments, the biological sample comprises a sample from a virus, a bacterium, a protist, a eukaryote, an animal, a human, a plant, or any other suitable biological source. In certain embodiments, the biological sample comprises saliva, sputum, blood, plasma, serum, urine, stool, cerebral spinal fluid, bile fluid, lymph fluid, or any suitable biological sample tentatively comprising an analyte of interest.

In certain embodiments, the sample comprises an environmental sample, for example a sample sourced from the physical environment. In certain embodiments, the environmental sample comprises a soil sample, a water sample, an air sample, or a waste sample. In certain embodiments wherein the sample comprises a water sample, the water sample comprises a reservoir sample, a well water sample, a lake sample, a river sample, an ocean sample, a wetland sample, an ice sample, or any suitable environmental sample tentatively comprising an analyte of interest.

In certain embodiments, the sample comprises an industrial sample, for example a sample sourced from an industrial facility or factory, industrial waste, a waste stream from an industrial facility or factory, or an environment directly used for an industrial process. In certain embodiments, the industrial sample comprises an industrial product, precursor, or intermediate thereof, for example a production chemical derived from one or more synthetic steps wherein the purity and/or yield of the sample is to be determined, such as dyes, ingredients, preservatives, sweetening agents, food and cosmetic products, or any suitable industrial sample tentatively comprising an analyte of interest.

In certain embodiments, the sample comprises an agricultural sample. In certain embodiments, the agricultural sample is sourced from an agricultural location such as a farm, a field, an animal pen, a body of water for agricultural use, such as a farm site for sea fauna or sea flora or a paddy. In certain embodiments, the agricultural sample comprises a soil sample, a plant sample, a livestock sample, a water sample, a food sample, or any suitable agricultural sample tentatively comprising an analyte of interest.

In certain embodiments, the analyte of interest comprises a molecule, for example a molecule sized up to about 50,000 Da, up to about 20,000 Da, up to about 10,000Da, up to about 5,000 Da, up to about 2,000 Da, or up to about 1,000 Da, for example 50-50,000Da. The analyte can be any suitable molecule, for example an organic molecule or an inorganic molecule. In certain embodiments, the analyte comprises a small organic molecule, for example a drug with a size of less any of 5,000 Da, 2,000 Da, 1,000 Da, or 500 Da.

The one or more analytes, e.g., compounds of interest, can be, for example, cocaine, an opioid, ayahuasca, a central nervous system depressant, DMT, GHB, a hallucinogen, heroin ketamine, KHAT, LSD, MDMA (ecstasy/molly), mescaline (peyote), methamphetamine, an over-the-counter medicine, including but not limited to dextromethorphan, loperamide, and the like, PCP, a prescription medication, a stimulant, psilocybin, rohypnol (flunitrazepam), saliva, steroids (anabolic), a cannabinoid or a variant thereof, cathinone (bath salts), or any other suitable analyte of interest.

In certain embodiments, the analyte can be one or more controlled substances. In certain embodiments, the analyte can be a drug. In certain embodiments, the analyte can be a cannabinoid. In certain embodiments, the cannabinoid can comprise 10-ethoxy-9-hydroxy-delta-6a-tetrahydrocannabinol, 10-oxo-delta-6a-tetrahydrocannabinol (OTCH), 2-arachidonoylglycerol (2AG), 2-arachidonyl glyceryl ether, 8,9-dihydroxy-delta-6a-tetrahydrocannabinol, anandamide (AEA), cannabichromanon (CBCN), cannabichromene (CBC), cannabichromenevarin (CBCV), cannabichromenic Acid (CBCA), cannabichromevarinic acid (CBCVA), cannabicitran (CBT-C), cannabicyclol (CBL), cannabicyclolic acid (CBLA), cannabicyclovarin (CBLV), cannabidiol (CBD), cannabidiol monomethylether (CBDM), cannabidiolic acid (CBDA), cannabidiorcol (CBDC1), cannabidiorcol (CBN-C1), cannabidivarin (CBDV), cannabidivarinic acid (CBDVA), cannabielsoic acid A (CBEA-A), cannabielsoic acid B (CBEA-B), cannabielsoin (CBE), cannabifuran (CBF), cannabigerol (CBG), cannabigerol monomethylether (CBGM), cannabigerolic Acid (CBGA), cannabigerolic acid monomethylether (CBGAM), cannabigerovarin (CBGV), cannabigerovarinic acid (CBGVA), cannabiglendol-C3, cannabinodiol (CBND), cannabinodivarin (CBV), cannabinodivarin (CBVD), cannabinol (CBN), cannabinol methylether (CBNM), cannabinol-C2 (CBN-C2), cannabinol-C4 (CBN-C4), cannabinolic acid (CBNA), cannabiripsol (CBR), cannabitriol (CBT), cannabitriolvarin (CBTV), dehydrocannabifuran (CBFD), delta-8-tetrahydrocannabinol (Δ8-THC), delta-8-tetrahydrocannabinolic acid (Δ8-THCA), delta-9-cis-tetrahydrocannabinol (CIS-THC), delta-9-tetrahydrocannabinol (Δ9-THC), delta-9-tetrahydrocannabinol-C4(Δ9-THC-C4), delta-9-tetrahydrocannabinolic acid A (Δ9-THCA-A), delta-9-tetrahydrocannabinolic acid B (Δ9-THCA-B), delta-9-tetrahydrocannabinolic acid C4 (Δ9-THCA-C4), delta-9-tetrahydrocannabiorcol (Δ9-THCA-C1), delta-9-tetrahydrocannabiorolic acid C1 (Δ9-THCA-C1), delta-9-tetrahydrocannabivarin (THCV), delta-9-tetrahydrocannabivarinic acid (THCVA), lysophosphatidylinositol (LPI), N-arachidonoyl dopamine (NADA), tetrahydrocannabinol (THC), trihydroxy-delta-9-tetrahydrocannabinol (TRIOH-THC), virodhamine (OAE), or a variant thereof. The variant can comprise either a natural or synthetic variant.

The articles, systems, and methods disclosed herein can quickly, e.g., in 20 min or less, provide accurate and precise quantitative analysis of one or more analyte. The analyte can be present in dilute concentrations in the sample, and the apparatus, systems, and methods configured to enable quantification of the dilute analytes. In certain embodiments, the articles, systems, and methods allow the analysis of a large volume, e.g., at most about any of 5 mL, 4 mL, 3 mL, 2 mL, 1 mL, 0.5 mL, 0.25 mL, or 0.1 mL, of a sample comprising an analyte, for example at most about 2 mL of sample comprising an analyte.

Methods disclosed herein can comprise any suitable method for performing separation and/or concentration of at least one analyte in a sample. Methods disclosed herein can comprise any suitable method for detecting at least one separated and/or concentrated analyte. Methods disclosed herein can comprise any suitable method for applying an indicator, e.g., a dye, to the chromatography medium. As used herein, the terms “indicator” and/or “dye” include any compound that changes a property of an analyte. Typically, the indicators and/or dyes change the properties of the analyte in such a way as to enable and/or improve detection of the analyte, for example, by attaching a detectable label. Methods disclosed herein can comprise any suitable method for quantifying at least one separated and/or concentrated analyte.

Articles disclosed herein can comprise a flat, solid substrate coated at least in portion with chromatography medium. The article can contain any number of fluidic barriers and/or gates to direct the flow of solvent, and as a result, direct the flow of analytes and non-analytes in the sample across the chromatography medium. The article can comprise one or more reference standard to aid in quantification of the one or more analyte.

Systems disclosed herein can comprise a receiving area for disclosed articles, at least one solvent chamber configured such that the at least one solvent chamber is in fluid communication with at least a portion of the chromatography medium, and/or a detector. The system and the article can be configured such that the article is in the form of a replaceable cartridge and the system is configured in such a way to receive the replaceable cartridge. The system can be configured such that the cartridge is oriented horizontally or vertically.

### II. Articles

### A. Substrates

In certain embodiments, the article comprises a solid substrate. The substrate can comprise any suitable material, for example, glass, quartz, metal, aluminum, plastic, or a suitable alternative. The substrate can comprise any suitable shape. In certain embodiments, the substrate can be triangular, rectangular, square, trapezoidal, rhomboidal, triangular, pentagonal, hexagonal, heptagonal, octagonal, circular, elliptical, or the like. In certain embodiments, the substrate comprises a thickness of at least about any of 0.1 mm, 0.25 mm, 0.5 mm, 0.75 mm, 1 mm, 2 mm, 3 mm, 4 mm, 5 mm, 6 mm, 7 mm, 8 mm, 9 mm, or 10 and/or no more than about any of 0.1 mm, 0.25 mm, 0.5 mm, 0.75 mm, 1 mm, 2 mm, 3 mm, 4 mm, 5mm, 6 mm, 7 mm, 8 mm, 9 mm, 10 mm, or 20 mm, for example, the substrate comprises a thickness of about 0.1 to about 20 mm, preferably, the substrate comprises a thickness of about 0.1 to about 5 mm, more preferably about 0.1 um to about 2 mm, yet more preferably about 0.1 um to about 1 mm. In certain embodiments, the substrate comprises 3 geometric axes, a first axis comprising the thickness of the substrate (herein referred to as the z-axis) and two additional, coplanar axes typically about perpendicular to the first axis. The second axis refers to the length of the substrate (herein termed the “x-axis” or the “first dimension” of the substrate), and the third axis refers to the width of the substrate (herein termed the “y-axis” or the “second dimension” of the substrate). The first and the second dimensions of the substrate can be at any angle relative to each other. In certain embodiments, the second dimension is at an angle between about 45 degrees and about 135 degrees, between about 75 degrees and about 105 degrees, between about 80 degrees and about 100 degrees, or about 85 degrees and about 95 degrees of the first dimension. In certain embodiments, the second dimension is about orthogonal to the first dimension. In certain embodiments the second dimension is substantially orthogonal to the first dimension. In certain embodiments, the substrate can comprise a first dimension and/or a second dimension of at most about any of 50 cm, 45 cm, 40 cm, 35 cm, 30 cm, 25 cm, 20 cm, 15 cm, 10 cm, 5 cm, 4 cm, 3 cm, 2 cm, 1 cm, or 0.5 cm and/or at least about any of 45 cm, 40 cm, 35 cm, 30 cm, 25 cm, 20 cm, 15 cm, 10 cm, 5 cm, 4 cm, 3 cm, 2 cm, 1 cm, 0.5 cm, or 0.25 cm long, for example, about 50 to about 0.25 cm long, preferably about 30 to about 5 cm long, more preferably about 30 to about 20 cm long, yet more preferably at most about 25 cm long. In certain embodiments, the length of the first dimension and the length of the second dimension are not the same. In certain embodiments, the length of the first dimension and the length of the second dimension are the same.

### B. Chromatography Medium

In certain embodiments, the substrate is at least partially coated with a chromatography medium. In certain embodiments, the top surface of the substrate is at least about any of 70%, 80%, 90%, 95%, 96%, 97%, 98%, 99%, or 99.5% and/or no more than about any of 80%, 90%, 95%, 96%, 97%, 98%, 99%, 99.5%, or 100% coated with chromatography medium, for example about 70% to about 100% coated with chromatography medium, preferably about 85% to about 100% coated with chromatography medium. The chromatography medium can comprise any suitable medium as recognized by a skilled artisan. In certain embodiments, the chromatography medium can comprise silica, alumina, cellulose, polyamide, or the like. In certain instances, the chromatography medium can comprise one or more chemical modifications such as C2, C8, C10, C18, phenol, amine, and/or chiral. In certain embodiments, the chromatography medium can be functionalized with any suitable chemical modification. In certain embodiments, the chromatography medium can be functionalized with C2, C8, C18, or any other suitable alternative as recognized by a skilled artisan. In certain embodiments, the chromatography medium can comprise a fluorescent molecular whereby the chromatography medium fluorescence upon exposure to electromagnetic radiation, for example compounds which fluoresce upon exposure to short wavelength UV, e.g., 254 nm, such as tin-activated strontium compounds, uranyl acetate, magnesium-activated zinc silicate, zinc cadmium sulfide, and the like. In certain embodiments, the chromatography medium comprises an average particle size ranging from 1 um to 50 um. In certain embodiments, the chromatography medium can comprise any suitable thickness for the application. In certain embodiments, the thickness of the chromatography medium comprises at most about any of 500 um, 400 um, 300 um, 200 um, 100 um, 75 um, 50 um, or 25 um and/or at least about any of 400 um, 300 um, 200 um, 100 um, 75 um, 50 um, 25 um, or 10 um, for example the thickness of the chromatography medium comprises about 500 um to about 10 um.

In certain embodiments, the chromatography medium is attached to the substrate using a binder. The binder can be any suitable binder, for example an organic binder, an inorganic binder, and/or gypsum.

### C. Partitions, Zones, and Gates

In certain embodiments, any combination of separation and/or concentration can occur along any of the dimensions of the substrate. In certain embodiments, an analyte can be separated from non-analytes along a first dimension of the substrate, and subsequently an analyte can be separated from non-analytes along a second dimension of the substrate. In certain embodiments, an analyte can be separated from non-analytes along a first dimension of the substrate, and subsequently an analyte can be concentrated along a second dimension of the substrate. In certain embodiments, an analyte can be concentrated along a first dimension of the substrate, and subsequently an analyte can be separated from non-analytes along a second dimension of the substrate. In certain embodiments, an analyte can be concentrated along a first dimension of the substrate, and subsequently an analyte can be concentrated along a second dimension of the substrate. In any one of the embodiments, an analyte can then once again be separated from a non-analyte or further concentrated along the first and/or second dimensions of the substrate.

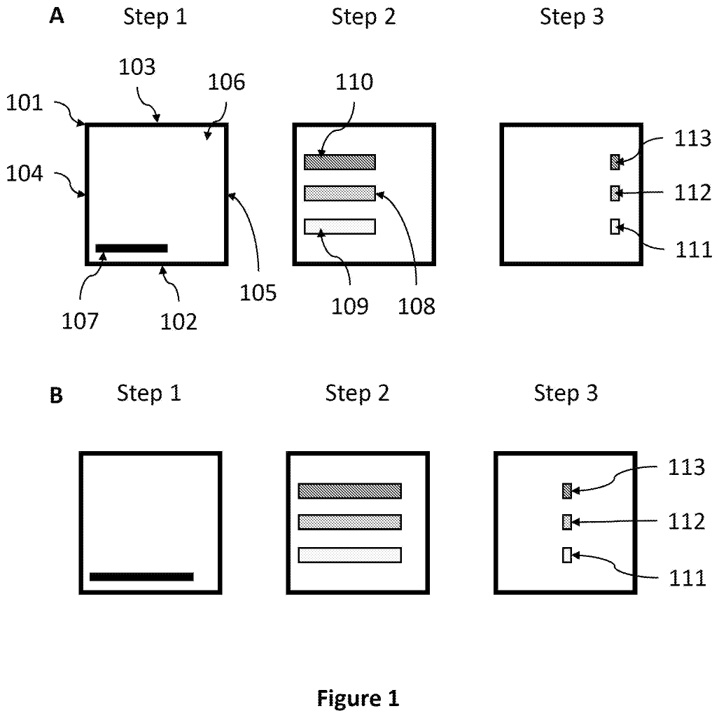

An exemplary article (101) is shown in FIGS. 1A and 1B. The exemplary article can comprise a solid substrate comprising four edges, wherein a first edge (102) is opposite to a third edge (103) and a second edge (104) is opposite to a fourth edge (105). The exemplary article can comprise chromatography medium on the substrate (106). The exemplary article can comprise a sample loading zone (107) positioned adjacent to, but not in contact with, the first (102) and second (103) edges of the substrate. As used herein, the term “separation zone” can include the area encompassing the sample loading zone and the area between the sample loading zone and the third edge (103) of the substrate. As used herein, the term “concentration zone” can include the area encompassing the sample loading zone and the area between the sample loading zone and the fourth edge (105) of the substrate. As used herein, the “sample loading zone” can include an area of the substrate configured for the application or loading of a sample.

In certain embodiments, the sample loading zone can comprise an elongate shape. In certain embodiments, the sample loading zone can comprise a long axis about parallel to the second dimension of the substrate and a short axis about parallel to the first dimension of the substrate. In certain embodiments, the ratio of the length of the long axis to the short axis of the sample loading zone is about 20:1, about 15:1 about 10:1, about 9:1, about 8:1, about 7:1, about 6:1, about 5:1, about 4:1, about 3:1, about 2:1, for example about 10:1. In certain embodiments, the long axis of the sample loading zone can span at least about any of 99%, 98%, 97%, 96%, 95%, 90%, 80%, 70%, 60%, 50%, 25%, or 10% and/or at most about any of 100%, 99%, 98%, 97%, 96%, 95%, 90%, 80%, 70%, 60%, 50%, or 25% of the length of the second dimension of the substrate, for example between about 100% and 10% of the length of the second dimension of the substrate. In certain embodiments, the long axis of the sample loading zone is at least about any of 2.5 mm, 5 mm, 7.5 mm, 10 mm, 15 mm, 20 mm, 25 mm, 30 mm, 35 mm, 40 mm, 45 mm, 50 mm, 100 mm, 150 mm, 200 mm, or 250 mm and/or no more than about any of 5 mm, 7.5 mm, 10 mm, 15 mm, 20 mm, 25 mm, 30 mm, 35 mm, 40 mm, 45 mm, 50 mm, 100 mm, 150 mm, 200 mm, 250 mm, or 500 mm long, for example between about 2.5 mm and about 500 mm long, preferably, between 50 mm and 500 mm long. In certain embodiments, the sample loading zone has a capacity between about 1 uL and about 2 mL, preferably about 100 uL to about 1 mL, more preferably about 250 uL to about 750 uL, even more preferably about 400 uL to about 600 uL.

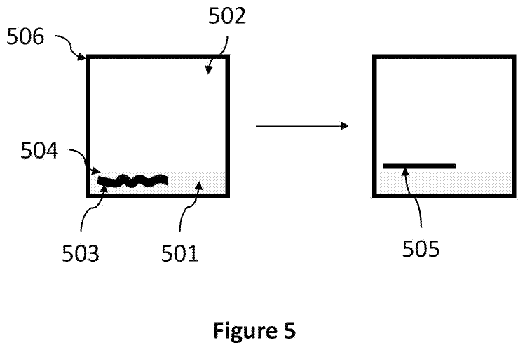

In certain embodiments, the chromatography medium comprising the sample loading zone (501) can comprise a separate chromatography medium from that of the separation and/or concentration zones (502). In such an embodiment, the chromatography medium surrounding the sample loading zone (501) can comprise different chemical and physical properties than the chromatography medium in the separation and/or concentration zones (502) and thereby interact with the constituents of the sample differently. In certain embodiments, the sample (503) can travel, e.g., develop, at a faster rate in the chromatography medium surrounding the sample loading zone than in the separation and/or concentration zones. In such a case, upon addition of solvent, a sample (503) spanning a large area of the chromatography medium would concentrate into a tighter area (505) as the sample traverses across the boundary due to the front of the sample slowing down upon entry into the second medium while the remainder of the sample continues at the faster rate. Further, samples unevenly loaded (503) can resolve into a linear area (505), which can improve analytical performance. An exemplary article (506) illustrating the described structure and effect is shown in FIG. 5.

In certain embodiments, the solid substrate is at least partially coated with chromatography medium. In certain embodiments, the solid substrate comprises chromatography medium on the surface of the substrate through which liquid phase can travel and comprises one or more barriers, the barrier comprising an area of substrate reduced in chromatography medium across which a liquid phase cannot travel. In certain embodiments, the one or more barriers span at least a portion of the length between the first and the third edge of the substrate, i.e., along the first dimension of the substrate. In certain embodiments, the one or more barriers span at least a portion of the length between the second and the fourth edge of the substrate, i.e., along the second dimension of the substrate.

In certain embodiments, the barrier comprises two barriers and a gate, the gate comprising an area of substrate where chromatography medium remains and liquid phase can travel, along the first dimension of the substrate, wherein the first barrier is in contact with the first edge of the substrate, the second barrier is in contact with the third edge of the substrate, and a gate is positioned between the first and the second barrier.

In certain embodiments, the substrate comprises any number of barriers and/or gates along the first dimension in the chromatography medium.

In certain embodiments, the one or more barriers and/or gates in the first dimension are offset from the second or fourth edge of the substrate. In certain embodiments, the one or more barriers and/or gates are offset from the second or fourth edge of the substrate by at least about any of 0.1 cm, 0.2 cm, 0.3 cm, 0.4 cm, 0.5 cm, 0.6 cm, 0.7 cm, 0.8 cm, 0.9 cm, 1 cm, 1.5 cm, 2 cm, 2.5 cm, or 5 cm and/or no more than about any of 0.2 cm, 0.3 cm, 0.4 cm, 0.5 cm, 0.6 cm, 0.7 cm, 0.8 cm, 0.9 cm, 1 cm, 1.5 cm, 2 cm, 2.5 cm, 5 cm, or 10 cm from the edge of the substrate, for example, about 0.1 cm to about 10 cm from the edge of the substrate, preferably between about 1 cm to about 10 cm from the edge of the substrate. In certain embodiments, the barrier and/or gates are colinear. In certain embodiments the one or more barriers and/or gates are offset from each other.

In certain embodiments, the one or more barriers and/or gates are at an angle between about 45 degrees and about 135 degrees, between about 75 degrees and about 105 degrees, between about 80 degrees and about 100 degrees, or about 85 degrees and about 95 degrees second or fourth edge of the substrate. In certain embodiments, the one or more barriers and/or gates are at an angle between about 45 degrees and about 135 degrees, between about 75 degrees and about 105 degrees, between about 80 degrees and about 100 degrees, or about 85 degrees and about 95 degrees of the first dimension of the substrate.

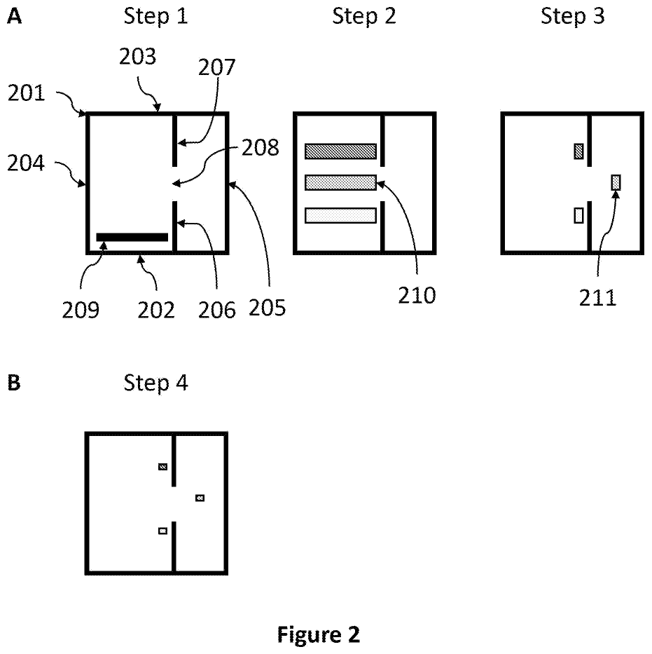

An exemplary article (201) is shown in FIG. 2. The exemplary article can comprise a solid substrate comprising four edges, wherein a first edge (202) is opposite to a third edge (203) and a second edge (204) is opposite to a fourth edge (205). The exemplary article can comprise chromatography medium on at least a portion of the substrate. The exemplary article can comprise one or more barriers on the substrate (206 and 207) across which a liquid phase cannot travel. The exemplary article can comprise a first barrier (206) that spans a portion of the length of the substrate wherein a first end of the first barrier is in contact with the first edge (202) of the substrate and a second end of the first barrier resides at a point interior to the substrate. The exemplary article can comprise a second barrier (207) that spans a portion of the length of the substrate wherein a first end of the second barrier is in contact with the third edge (203) of the substrate and a second end of the second barrier resides at a point interior to the substrate. The exemplary article can comprise a gate (208) positioned between the first (206) and second (207) barriers configured such that liquid phase can transport a separated analyte (210) through the gate (208), where chromatography medium remains, such that the analyte travels further (211) than non-analytes. The exemplary article can comprise a sample loading zone (209) positioned adjacent to, but not in contact with, the first (202) and second (203) edges of the substrate.

In certain embodiments, one or barriers in the second dimension can contact and/or intersect one or more barriers in the first dimension. In certain embodiments, one or more ends of the barriers in the first and/or second dimension may contact an edge of the substrate. In certain embodiments, the ends of the barriers contact the substrate fluidically isolating one area of chromatography medium from another.

In certain embodiments, at least a portion of the chromatography medium is surrounded by a barrier resulting in two fluidically isolated areas of chromatography medium. In a further embodiment, a second portion of the chromatography medium is surrounded by a second barrier resulting in a third fluidically isolated area of chromatography medium.

In certain embodiments, the article can comprise at least any of 1, 2, 3, 4, 5, 6, 7,8, 9, or 10 and/or no more than any of 2, 3, 4, 5, 6, 7, 8, 9, 10, or 20 fluidically isolated areas, for example at least 3, at least 4, or at least 5 fluidically isolated areas. In a preferred embodiment, the article comprises between 3 and 5 fluidically isolated areas.

In certain embodiments, the barrier comprises two barriers and a gate, the gate comprising an area of substrate where chromatography medium remains and liquid phase can travel, along the first dimension of the substrate, wherein the first barrier is in contact with the first edge of the substrate, the second barrier is in contact with the third edge of the substrate, and a gate is positioned between the first and the second barrier. In certain embodiments, the first barrier extends from the end of the first barrier opposite the first edge of the substrate to either the second or fourth edge of the substrate; and the second barrier extends from the end of the second barrier opposite the third edge of the substrate to either the second or fourth edge of the substrate, thereby forming three fluidically disconnected regions.

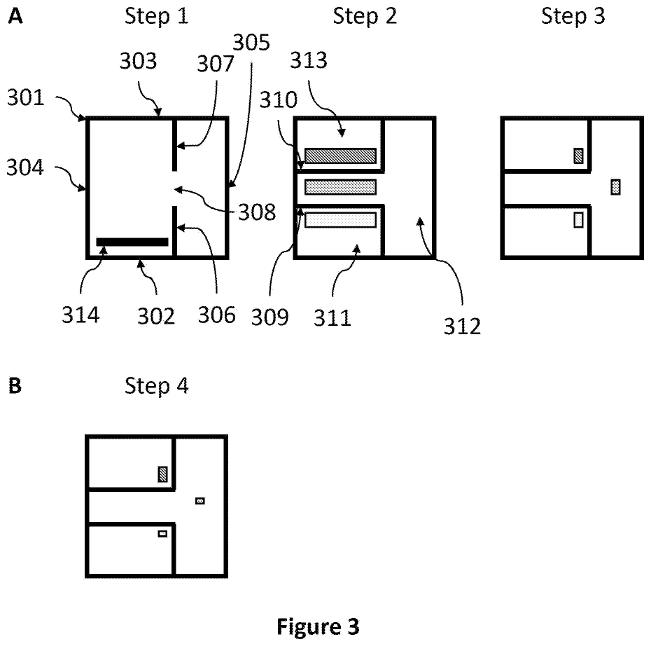

An exemplary article (301) is shown in FIG. 3. The exemplary article can comprise a solid substrate comprising four edges, wherein a first edge (302) is opposite to a third edge (303) and a second edge (304) is opposite to a fourth edge (305). The exemplary article can comprise chromatography medium on at least a portion of the substrate. The exemplary article can comprise one or more barriers on the substrate (306 and 307) across which a liquid phase cannot travel. The exemplary article can comprise a first barrier (306) that spans a portion of the length of the substrate wherein a first end of the first barrier is in contact with the first edge (302) of the substrate and a second end of the first barrier resides at a point interior to the substrate. The exemplary article can comprise a second barrier (307) that spans a portion of the length of the substrate wherein a first end of the second barrier is in contact with the third edge (303) of the substrate and a second end of the second barrier resides at a point interior to the substrate. The exemplary article can comprise a gate (308) positioned between the first (306) and second (307) barriers configured such that liquid phase can transport a separated analyte through the gate (308), where chromatography medium remains, such that the analyte travels further (311) than non-analytes. The first barrier can be extended from the end of the first barrier opposite the first edge of the substrate to either the second or fourth edge of the substrate (309), and the second barrier can be extended from the end of the second barrier opposite the third edge of the substrate to either the second or fourth edge of the substrate (310), thereby forming three fluidically disconnected regions (311, 312, and 313). The exemplary article can comprise a sample loading zone (314) positioned adjacent to, but not in contact with, the first (202) and second (203) edges of the substrate.

### D. Chromatography Maze

In certain embodiments, an article can comprise two or more substrates with at least a portion of the substrates coated in chromatography medium linked together via a gate. The gate fluidically connects the chromatography medium of one or more substrates to the chromatography medium of one or more additional substrates.

In certain embodiments, a single substrate can contain multiple fluidic barriers allow for manipulation of the travel of the fluid as it translates across the surface of the substrate.

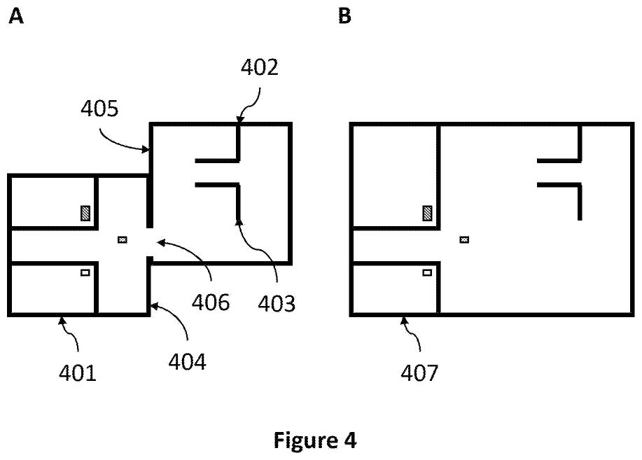

An exemplary article (401) is shown in FIG. 4A. The exemplary article can comprise two solid substrates comprising each of which comprise four edges. The first substrate can comprise an exemplary article as described in FIG. 2 or 3. The second substrate can comprise an exemplary article as described in FIG. 1, 2 or 3. The first (402) and/or second (403) barrier on the second substrate can or cannot contact the edges of the substrate depending on the application. The first substrate and the second substrate can be adjacent to each other such as the fourth edge (404) of the first substrate and the second edge (405) of the second substrate are in contact with each other. The chromatography medium of the first and second substrate can be fluidically connected via a gate (406), wherein the bridge comprises chromatography medium. This illustrative exemplary article can be configured in any manner as necessary for the application. The exemplary article (407), as shown in FIG. 4B, can comprise all the elements of the article in FIG. 4A on a single substrate.

### E. Perforated Substrates

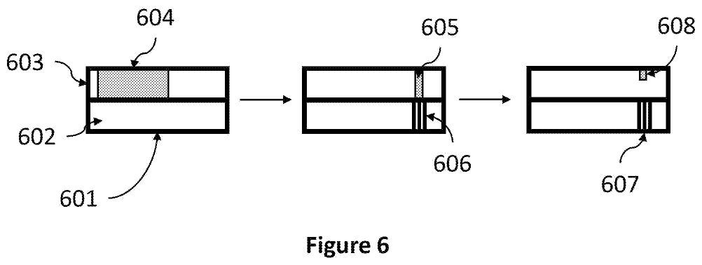

In certain embodiments, the article can comprise small holes drilled about along the first axis of the substrate through the substrate to the chromatography medium. In certain embodiments, solvent may be applied to the bottom of the substrate. In certain cases, the solvent may travel through the holes in the substrate towards the surface of the chromatography medium. In certain cases, as the solvent travels towards the surface of the chromatography medium, one or more analyte is the sample can migrate to the surface of the chromatography medium. In certain cases, the migration of one or more analytes to the surface of the chromatography medium can increase the local concentration of the analyte at the surface of the chromatography medium. In certain cases, the increased local concentration of analyte at the surface of the chromatography medium can improve the quantification of the analyte. An illustrative exemplary article (601) is shown in FIG. 6. In the exemplary article, a cross section of a substrate (602) at least partially coated with chromatography medium (603) is shown. The sample or a component of the sample (604) is present on a portion of the chromatography medium. The sample or component of the sample (604) can migrate across the chromatography medium by application of a solvent to the edge of the substrate (603) resulting in a migrated sample (605) in a different area than the original. Small holes (606) in the substrate underneath the migrated sample can enable application of a solvent to the bottom of the substrate (607), wherein solvent can travel from the bottom of the substrate towards the surface of the chromatography medium resulting in a sample or component of the sample (608) concentrated at the surface of the chromatography medium. Any number of holes may be present in the substrate in any location of the substrate as deemed necessary for the respective application. The holes may be of any size suitable for the flow of solvent.

### F. Substrates Comprising Multiple Types of Chromatography Medium

In certain embodiments, the barrier in the chromatography medium may be constructed by acquiring a substrate already coated in chromatography medium and removing the chromatography medium from the required area. In certain embodiments, the barrier in the chromatography medium may be constructure by acquiring a substrate, coating the substrate in chromatography medium, and removing the chromatography medium from the required areas. The chromatography medium can be removed using any suitable method, for example etching, scoring, milling, and/or embossing. In certain embodiments, the barrier in the chromatography medium may be constructed by acquired a substrate, applying a mask, e.g., tape or any other suitable alternative, applying the chromatography medium to the substrate, and then removing the mask.

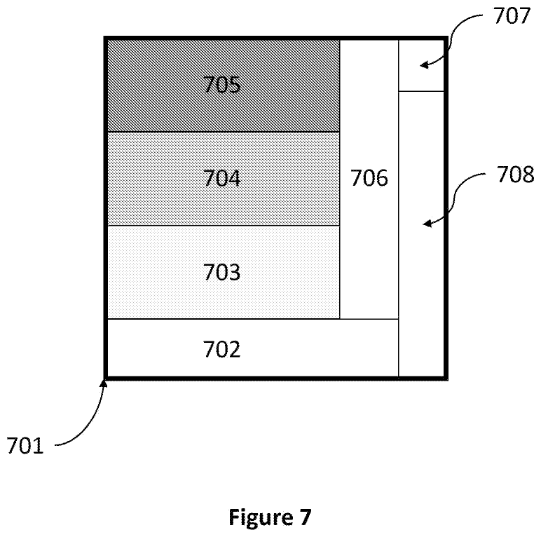

In certain embodiments, the separation and concentration zone can comprise multiple distinct subzones each of which can comprise a different chromatography medium. Any number of distinct subzones may be applied as necessary for the application. An exemplary article (701) is shown in FIG. 7. The exemplary article can comprise (a) a concentration zone (702) comprising, for example, silica chromatography medium, (b) a fast speed zone (703) comprising, for example, C2-functionalized chromatography medium, (c) a medium speed zone (704) comprising, for example, C8-functionalized chromatography medium, (d) a slow speed zone (705), comprising, for example, C18-functionalized chromatography medium, (e) a functional separation zone (706), (f) a calibration zone (706), and (g) an indicator zone (708). A skilled artisan will recognize that the article can comprise any number of zones comprising any chromatography medium depending on the application.

### G. Covering Layers

In certain embodiments, the article can comprise a covering layer wherein the covering layer covers at least a portion of the chromatography medium. In certain cases, the covering layer may prevent or slow the evaporation of solvent from the covered areas of the chromatography medium. In certain cases, it may be beneficial to the application for a portion of the chromatography medium to evaporate at a different rate than another portion of the chromatography medium. In certain embodiments, the covering layer may be applied to the chromatography medium during manufacture or by the user during use of the article.

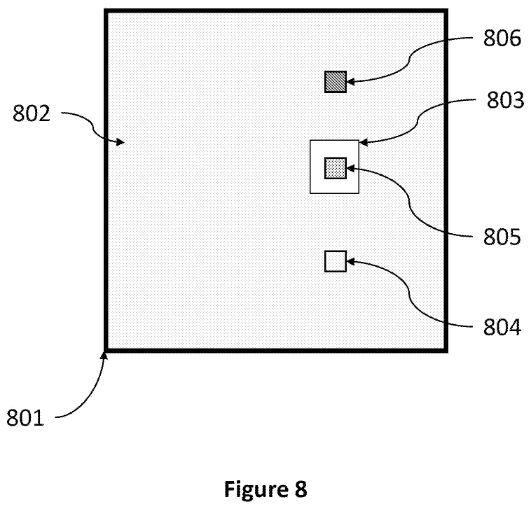

An exemplary article (801) is shown in FIG. 8. The exemplary article comprises an article of FIG. 1. It should be understood that any article may be used in place of the article of FIG. 1 as necessary for the application. A covering layer (802) that covers at least a portion of the chromatography medium is applied to the chromatography medium. A portion of the chromatography medium is exposed to the external atmosphere, e.g., air or a generated atmosphere (803). The chromatography may comprise any number of analyte and non-analyte molecules (804, 805, or 806) that are either exposed to the external atmosphere or covered by the covering layer.

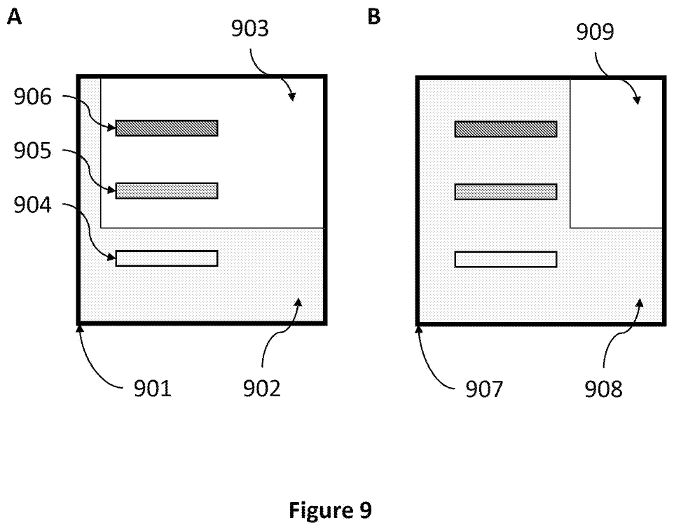

Additional exemplary articles area shown in FIG. 9. The exemplary article (901) of FIG. 9A comprises a covering layer (902) that covers at least a portion of the chromatography medium applied to the chromatography medium. A portion of the chromatography medium is exposed to the external atmosphere (903). The chromatography may comprise any number of analyte and non-analyte molecules (904, 905, or 906) that are either exposed to the external atmosphere or covered by the covering layer. In this example a portion of the analytes and non-analytes are covered by the covering layer while a remainder of the analytes and non-analytes are exposed to the external atmosphere. The exemplary article (907) of FIG. 9B comprises a covering layer (908) that covers at least a portion of the chromatography medium applied to the chromatography medium. A portion of the chromatography medium is exposed to the external atmosphere (909). The chromatography may comprise any number of analyte and non-analyte molecules (904, 905, or 906) that are either exposed to the external atmosphere or covered by the covering layer. In this example the analytes and non-analytes are covered by the covering layer. In the exemplary articles shown in FIG. 9, the article comprises an article of FIG. 1 with an additional covering layer. It should be understood that any article may be used in place of the article of FIG. 1 as necessary for the application.

In certain embodiments, the cover enables the TLC plate to be run horizontally with the chromatography medium facing towards or away from the base of the receiving area, i.e., a “face down” or “face up” configuration, respectively.

H. Substrates comprising calibrants

In certain embodiments, the article comprises a calibrant. As used herein, a “calibrant” includes any molecule identical or similar to an analyte that is applied at one or more amounts onto the chromatography medium. The calibrants can provide an expected signal upon detection. In certain embodiments, the one or more calibrants can be fluidically isolated from the rest of the plate. In other embodiments, the one or more calibrants can be adjacent to but not in contact with the sample, wherein the calibrant travels through the chromatography medium analogous to the one or more analytes in the sample. In certain embodiments, the calibrant and analyte are fluidically isolated during analysis. In certain embodiments, one or more calibrants are added to the chromatography medium during manufacturing, before use, during use, or after use. In certain embodiments, the calibrants are positioned within a gate such that separating and/or concentrating solvent are not able to disturb the calibrants during separation and/or concentration steps. The calibrants can be placed in any suitable position on the chromatography medium. It is typically preferred that the calibrants are placed outside of the path of travel of any component of the sample during the separation and/or concentration steps in order to prevent disruption of the solvent flow path. In certain embodiments, the calibrants are placed in an area fluidically isolated from the rest of the chromatography medium.

Any suitable number of calibrants can be placed on the substrate, such as no more than any of 10, 9, 8, 7, 6, 5, 4, 3, 2, or 1 different concentrations of an analyte to be quantified.

### I. Fluidic Reservoirs

In certain embodiments, the apparatus further comprises one or more fluidic reservoirs in contact with a surface of the chromatography medium, wherein a liquid phase applied to the fluidic reservoir is in fluid communication with the chromatography medium such that the liquid phase moves via capillary action through the chromatography medium. In certain embodiments, the fluidic reservoirs are not in contact with the edge of the chromatography medium or the edge of the solid substrate and/or wherein the liquid phase does not travel on top of the surface of the chromatography medium.

In certain embodiments, the article comprises (a) a solid substrate, (b) chromatography medium on the surface of the substrate through which liquid phase can travel; (c) one or more fluidic reservoirs in contact with a surface of the chromatography medium, wherein the fluidic reservoir enables application of a liquid phase to the surface of the chromatography medium such that the liquid phase is able to travel through the chromatography medium. In certain embodiments, the fluidic reservoirs are not in contact with the edge of the chromatography medium or the edge of the solid substrate and/or wherein the liquid phase does not travel on top of the surface of the chromatography medium.

The fluidic reservoirs can hold any suitable volume, such as at least any of 100 uL, 200 uL, 300 uL, 400 uL, 500 uL, 600 uL, 700 uL, 800 uL, 900 uL, 1,000 uL, 1,500 uL, or 2,000 uL and/or not more than 5 mL, for example 100 uL to 5 mL. Typically, the fluidic reservoirs are manufactured out of a material resistant and/or compatible with the solvent. Proper materials would be readily identifiable by one of skill in the art.

In certain embodiments, the fluidic reservoirs comprise one or more conduits operably configured to a supply of solvent.

Accordingly, reservoirs can be configured as open wells, such as an open-ended cylinder or block. They can be positioned on the chromatography plate in contact with the chromatography medium. In this way, the chromatography medium will function as a floor of the well, and fluid deposited in the open top of a reservoir will come into contact with the chromatography medium.

The reservoirs can be any suitable shape, such as triangular, rectangular, square, trapezoidal, rhomboidal, triangular, pentagonal, hexagonal, heptagonal, octagonal, circular, elliptical, or the like. Typically, the reservoirs comprise an elongated shape such that the solvent generates a linear solvent front along the length of the elongated reservoir.

The reservoirs can be any suitable length, such as at least about any of 2.5 mm, 5 mm, 7.5 mm, 10 mm, 15 mm, 20 mm, 25 mm, 30 mm, 35 mm, 40 mm, 45 mm, 50 mm, 100 35 mm, 150 mm, 200 mm, or 250 mm and/or no more than about any of 5 mm, 7.5 mm, 10 mm, 15 mm, 20 mm, 25 mm, 30 mm, 35 mm, 40 mm, 45 mm, 50 mm, 100 mm, 150 mm, 200 mm, 250 mm, or 500 mm long, for example between about 2.5 mm and about 500 mm long, preferably, between 50 mm and 500 mm long. The reservoirs can be any suitable width. In certain embodiments the ratio of the length of the reservoir to the width of the reservoir is no more than about any of 2:1, 3:1, 4:1, 5:1, 6:1, 7:1, 8:1, 9:1, 10:1, 15:1, or 20:1.

The reservoirs can be any suitable height, such as at least about any of 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, or 19 mm and/or not more than about any of 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm, for example 1-20 mm.

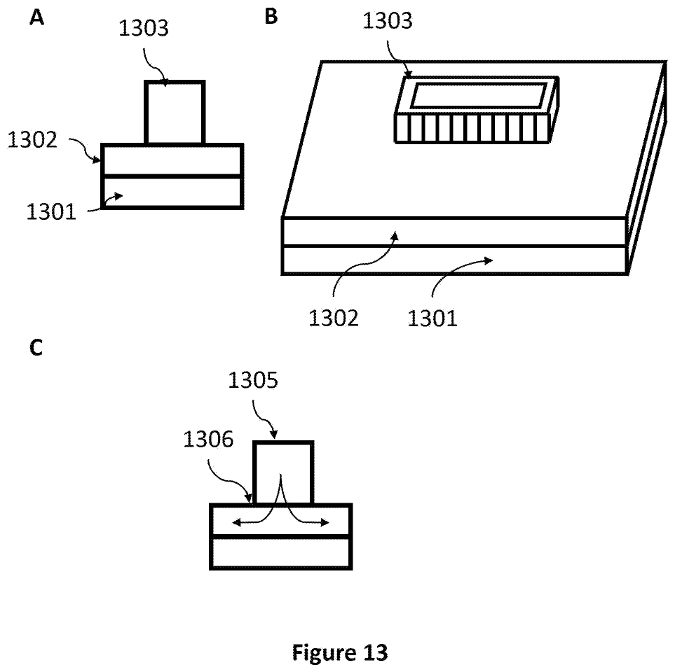

An exemplary article, e.g., TLC plate, comprising a fluidic reservoir is shown in FIG. 13. The exemplary article comprises a substrate (1301) with chromatography medium (1302) at least partially coated on the substrate. A fluidic reservoir (1303) is placed on top of the chromatography medium. The fluidic reservoir (1303) creates a seal against the chromatography medium (1302) such that any fluid placed in the fluidic reservoir (1303) doesn't through a junction (1306) between the fluidic reservoir (1303) and the chromatography medium (1302). A side view of the article is shown in FIG. 13A, and an angled view is shown in FIG. 13B. The fluid path (FIG. 13C) of a liquid phase (1305) placed into the fluidic reservoir (1303) is shown by the two arrows, which illustrates the liquid phase traveling radially outward via capillary action from the fluidic reservoir through the chromatography medium (1302) but not through the junction (1306).

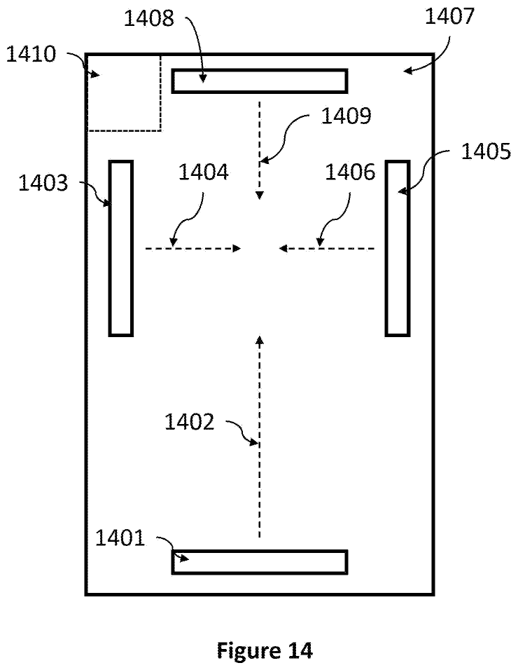

Another exemplary article is shown in FIG. 14. The exemplary article comprises a TLC plate (1407) comprising a substrate at least partially coated in chromatography medium. The TLC plate (1407) comprises at least 2, and optionally 3, fluidic reservoirs (1401, 1403, and 1405), wherein the first fluidic reservoir (1401) is configured to apply solvent in a first dimension (1402), the second fluidic reservoir (1403) is configured to apply solvent in a second dimension (1404), and the optional third fluidic reservoir (1405) is configured to apply solvent in a second dimension (1406) from the opposite direction as the second fluidic reservoir (1403). The second (1403) and third (1405) fluidic reservoirs can be filled with fluid either sequentially or simultaneously. In certain embodiments, the TLC plate (1407) comprises a fourth fluidic reservoir (1408) configured to apply solvent in the first dimension (1409) in a direction opposite of the first fluidic reservoir (1401). In certain embodiments, the first fluidic reservoir also serves as the sample loading zone.

### III. Systems

In certain embodiments provided herein are systems. In certain embodiments, provided herein are systems for processing a sample. In certain embodiments provided herein are systems for accurately and precisely quantifying dilute amounts of analyte in a sample. In certain embodiments, the system comprises one or more of the following components: (1) a body of material comprising a base and four walls, (2) a receiving area for a chromatography cartridge connected to the body, (3) at least one solvent chamber configured such that, when the chromatography cartridge is inserted into the receiving area, the solvent chamber is in fluidic communication with at least a portion of the chromatography medium, (4) a cover configured to mate with the cavity walls to provide a sealed environment, (5) one or more heating elements configured to be in contact with the chromatography cartridge of the body of material, (6) one or more air flow manipulators, (7) a detector, (8) an indicator, e.g., dye, applicator, and/or (9) a solvent collector and/or combustor.

In certain embodiments, the system comprises a body of material comprising a base and four walls. In certain embodiments, the material comprises a chemically resistant material. In certain embodiments, material comprises acetal, polyethylene terephthalate (PET), low density polyethylene (LDPE), high density polyethylene (HDPE), ultra high molecular weight polyethylene (UHMW), nylon, polybutylene terephthalate (PBT), acrylic, polyetheretherketone (PEEK), polypropylene, polyphenylene Sulfide (PPS), polyvinyl chloride (PVC), chlorinated polyvinyl-chloride (CPVC), polypropylene (PP), a fluoropolymer such as polyvinylidene fluoride (PVDF), ethylene chlorotrifluoroethylene (ECTFE), ethylene tetrafluoroethylene (ETFE), polytetrefluoroethylene (PTFE), polychlorotrifluoroethylene (PCTFE), fluorinated ethylene propylene (FEP), perfluoroalkoxy (PFA), metal, Hastelloy, glass, quartz, ceramic, silicone, viton (FKM), FFKM, or any suitable alternative.

In certain embodiments, the system comprises a receiving area is configured such that a chromatography cartridge as described above can be inserted into and removed from the receiving area. In certain embodiments, the article is placed into the receiving area upon which is rests on supports configured to contact the outer edges of the substrate and/or chromatography medium. In certain embodiments, the article and receiving area are configured to connect to each other through one or more mechanical connectors such as a clamp, button, clip, bevel and groove, hole and pin, or any suitable alternative.

In certain embodiments, the system comprises at least one solvent chamber comprising a line fluidically connected to the chromatography medium. In certain embodiments, the fluidic line comprises a tube or a channel in fluidic communication with the chromatography medium. In certain embodiments, the channel or tube can be a milli- or microfluidic tube or channel. In certain embodiments, the solvent is delivered to the chromatography medium via a pump, via capillary action, via gravity, via electroosmotic flow, electrokinesis, or any suitable alternative. In certain embodiments, the fluidic line terminates in one or more components that distribute the solvent across a length of the substrate longer than the length of the fluidic line itself. In certain embodiments, the one or more components that distribute the solvent across a length of the substrate longer than the length of the fluidic line itself comprises a brush. In certain embodiments, the brush comprises one or more bristles. In certain embodiments, the fluidic line is connected to the brush, wherein the solvent can travel from the solvent chamber, through the fluidic line, through the brush, and onto the substrate. In certain embodiments, the at least one solvent chamber, fluidic line, and/or brush application comprises a chemically resistant material such as acetal, polyethylene terephthalate (PET), low density polyethylene (LDPE), high density polyethylene (HDPE), ultra high molecular weight polyethylene (UHMW), nylon, polybutylene terephthalate (PBT), acrylic, polyetheretherketone (PEEK), polypropylene, polyphenylene Sulfide (PPS), polyvinyl chloride (PVC), chlorinated polyvinyl-chloride (CPVC), polypropylene (PP), a fluoropolymer such as polyvinylidene fluoride (PVDF), ethylene chlorotrifluoroethylene (ECTFE), ethylene tetrafluoroethylene (ETFE), polytetrefluoroethylene (PTFE), polychlorotrifluoroethylene (PCTFE), fluorinated ethylene propylene (FEP), perfluoroalkoxy (PFA), metal, Hastelloy, glass, quartz, ceramic, or any suitable alternative. In certain embodiments, the fluidic channel is in fluidic communication with the entire length of the chromatography medium. In certain embodiments, the fluidic channel is in fluidic communication with a portion of the entire length of the chromatography medium.

In certain embodiments, the system comprises a cover configured to mate with the cavity walls to provide a sealed environment. In certain embodiments, the cover and cavity are configured to connect to each other through one or more mechanical connectors such as a clamp, button, clip, bevel and groove, hole and pin, hinge, or any suitable alternative. In certain embodiments, the cover comprises a chemically resistant material such as acetal, polyethylene terephthalate (PET), low density polyethylene (LDPE), high density polyethylene (HDPE), ultra high molecular weight polyethylene (UHMW), nylon, polybutylene terephthalate (PBT), acrylic, polyetheretherketone (PEEK), polypropylene, polyphenylene Sulfide (PPS), polyvinyl chloride (PVC), chlorinated polyvinyl-chloride (CPVC), polypropylene (PP), a fluoropolymer such as polyvinylidene fluoride (PVDF), ethylene chlorotrifluoroethylene (ECTFE), ethylene tetrafluoroethylene (ETFE), polytetrefluoroethylene (PTFE), polychlorotrifluoroethylene (PCTFE), fluorinated ethylene propylene (FEP), perfluoroalkoxy (PFA), metal, Hastelloy, glass, quartz, ceramic, or any suitable alternative.

In certain embodiments, the system comprises one or more heating elements. In certain embodiments, the system comprises a heating element within the sealed chamber comprising the cavity with wall and the cover to maintain a controlled temperature. In certain cases, the controlled temperature may be used to control the rate of evaporation or improve the rate of molecular migration of the analytes and non-analytes through the chromatography medium in the presence of solvent. In certain embodiments, the system comprises one or more heating elements in contact with the substrate to provide a local region of heating. In certain embodiments, the heating element can promote evaporation of solvent. In certain embodiments, when fluidically connected to a source solvent, the heating element can promote continuous influx of new solvent as existing solvent is evaporated, generating a continuously flowing chromatography. In such a case, analyte and/or non-analyte in the surface would continue migrate through the chromatography medium in the continuous flow of solvent eventually concentrating at the point of evaporation. In certain cases, the continuous flow of solvent would concentrate analyte and/or non-analyte at the surface of the chromatography medium at the point of evaporation.

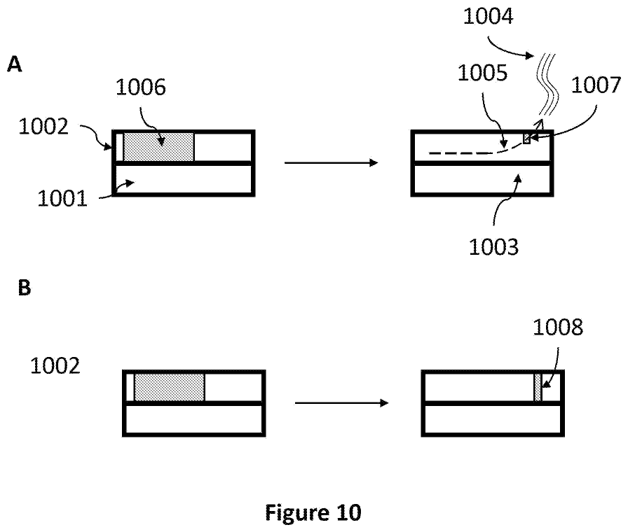

An exemplary system comprising a heating element in contact with an article is shown in FIG. 10. The exemplary system (FIG. 10A) comprises a substrate (1001) with chromatography medium (1002) at least partially coated on the substrate. The exemplary system further comprises a heating element (1003) in contact with a region of a substrate. The exemplary system further comprises a fluid chamber and/or reservoir in fluidic communication with the edge of the substrate (1002). Upon heating of the area of the substrate (1003) using the one or more heating element, solvent can evaporate (1004) and be drawn from the fluid reservoir generating a continuous flow of solvent (1005) from the fluid reservoir across the chromatography medium and towards the point of evaporation at the region of heating. One or more components of the sample (1006) can migrate in the continuous flow of solvent (1005) towards the surface of the substrate concentrating in an area near the surface of the chromatography medium (1007). This contrasts to a standard chromatography (FIG. 10B) run where the sample collects through the entire depth of chromatography medium (1008).

In certain embodiments, the system comprises one or more air flow manipulators. In certain embodiments, the air flow manipulator comprises a fan or a pump. In certain embodiments, manipulation of the air flow can promote solvent evaporation and/or maintenance of a desired temperature in the system. In certain embodiments, manipulation of the air flow can remove solvent from the TLC plate, for example by physically blowing off excess solvent.

In certain embodiments, the system comprises a detector. In certain embodiments, the detector is configured to measure at least one optical property of the analyte. In certain embodiments, the detector comprises an optical detector. In certain embodiments, the detector is configured to measure one or more of absorbance, fluorescence, reflectance, and/or optical rotation. In certain embodiments, the detector is configured to measure the property of one or more indicators, e.g., dyes, including but not limited to iodine, p-anisaldehyde, vanillin, permanganate, phosphomolybdic acid, iron (III) chloride, bromocresol green), o-Dianisidine bis(diazotized) zinc double salt, 2,5-Dimethoxy-4-([4-nitrophenyl]azo)benzenediazonium chloride hemi-zinc chloride salt, 5-chloro-2-methoxybenzenediazonium chloride hemi(zinc chloride) salt, (1S,2S)-2-(naphthalene-2,3-dicarboximido)cyclohexanecarboxylic acid, (1R,2R)-2-(naphthalene-2,3-dicarboximido)cyclohexanecarboxylic acid, or a suitable alternative.

In certain embodiments, the system comprises an indicator, e.g., dye, applicator. In certain embodiments, the indicator applicator comprises a sprayer configured to evenly coat the chromatography medium with a suitable indicator. In certain embodiments, the indicator applicator is configured to coat at least a portion of the chromatography medium. In certain embodiments, the indicator applicator is configured to coat the entire chromatography medium. In certain embodiments, the indicator applicator comprises a brush. In certain embodiments, the brush comprises a chemically resistant material, for example, a fluoropolymer, e.g., PTFE.

In certain embodiments, the system is configured to run the chromatography with the plate oriented about horizontally. In certain embodiments, the system is configured to run the chromatography with the plate oriented about vertically.

In certain embodiments, the system comprises a solvent collector and/or combustor. In certain embodiments, the solvent collector comprises a filter. In certain embodiments, the filter comprises any suitable material. In certain embodiments, the filter comprises activated carbon.

### IV. Methods

### A. Samples and Analytes

In certain embodiments provided herein are methods. In certain embodiments provided herein are methods for separating, concentrating, detecting, and/or quantifying one or more analyte in a sample. The analytes can be at any concentration in the sample. In certain embodiments, the one or more analytes can be at a dilute concentration. In certain embodiments, the methods disclosed herein are directed to the use of the articles and systems described above.

In certain embodiments, the analytes can be at any amount in the sample. In certain embodiments, the one or more analytes can be present at a dilute amount. In certain embodiments, the analyte is present in the mixture at a concentration of no more than about any of 1%, 0.9%, 0.8%, 0.7%, 0.6%. 0.5%, 0.4%, 0.3%, 0.2%, 0.1%, 0.09%, 0.08%, 0.07%, 0.06%, 0.05%, 0.04%, 0.03%, 0.02%, or 0.01% and/or at least about any of 0.9%, 0.8%, 0.7%, 0.6%, 0.5%, 0.4%, 0.3%, 0.2%, 0.1%, 0.09%, 0.08%, 0.07%, 0.06%. 0.05%, 0.04%, 0.03%, 0.02%, 0.01%, or 0.005% by weight of mixture, for example about 0.005% to about 1% by weight of mixture. In certain embodiments, the analyte comprises no more than about any of 1%, 0.9%, 0.8%, 0.7%, 0.6%. 0.5%, 0.4%, 0.3%, 0.2%, 0.1%, 0.09%, 0.08%, 0.07%, 0.06%, 0.05%, 0.04%, 0.03%, 0.02%, 0.01%, or 0.05% and/or at least about any of 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, or 0.005% of the total organic molecules in the mixture, for example between about 0.005% and about 1% of the total organic molecules in the mixture. In certain embodiments, the analyte is present in the mixture at a concentration of at least any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng and/or not more than any of any of 10 ng, 20 ng, 30 ng, 40 ng, 50 ng, 60 ng, 70 ng, 80 ng, 90 ng, 100 ng, 500 ng, 1,000 ng, 2,500 ng, 5,000 ng, or 10,000 ng of analyte per 500 uL of mixture, for example 0.1-10,000 ng of analyte per 500 uL of mixture, preferably 0.1-2,000 ng of analyte per 500 uL of mixture.

In certain embodiments, the article can be configured to accept a large volume of sample for analysis of a dilute amount of analyte in a sample. In certain embodiments, the article can be configured to accept a sample volume of at most about any of 10 mL, 5 mL, 2.5 mL, 2 mL, 1 mL, 0.5 mL, 0.25 mL, or 0.1 mL and/or at least about any of 5 mL, 2.5 mL, 2 mL, 1 mL, 0.5 mL, 0.25 mL, 0.1 mL, or 0.01 mL, for example about 0.01 mL to about 10 mL, preferably between 5 mL and 0.25 mL, more preferably between 2 mL and 0.5 mL.

In certain embodiments, the sample can be any sample as recognized by a skilled artisan. In certain embodiments, the sample can comprise one or more biological components. In certain embodiments, the sample can comprise a biological sample. In certain embodiments, the biological sample comprises saliva, sputum, blood, plasma, serum, urine, stool, cerebral spinal fluid, bile fluid, lymph fluid, or any alternative biological sample recognized by a skilled artisan. In certain embodiments, the sample can comprise an environmental sample comprising a soil sample, a water sample, or an air sample.

The one or more compound of interest, e.g., analyte, can be, for example, cocaine, an opioid, ayahuasca, a central nervous system depressant, DMT, GHB, a hallucinogen, heroin ketamine, KHAT, LSD, MDMA (ecstasy/molly), mescaline (peyote), methamphetamine, an over-the-counter medicine, including but not limited to dextromethorphan, loperamide, and the like, PCP, a prescription medication, a stimulant, psilocybin, rohypnol (flunitrazepam), saliva, steroids (anabolic), a cannabinoid or a variant thereof, cathinone (bath salts), or any other suitable analyte of interest. The one or more analytes can be in any suitable biological sample, environmental sample, or any suitable sample type of interest.

In certain embodiments, the analyte can be one or more controlled substances. In certain embodiments, the analyte can be a drug. In certain embodiments, the analyte can be a cannabinoid. In certain embodiments, the cannabinoid can comprise 10-ethoxy-9-hydroxy-delta-6a-tetrahydrocannabinol, 10-oxo-delta-6a-tetrahydrocannabinol (OTCH), 2-arachidonoylglycerol (2AG), 2-arachidonyl glyceryl ether, 8,9-dihydroxy-delta-6a-tetrahydrocannabinol, anandamide (AEA), cannabichromanon (CBCN), cannabichromene (CBC), cannabichromenevarin (CBCV), cannabichromenic Acid (CBCA), cannabichromevarinic acid (CBCVA), cannabicitran (CBT-C), cannabicyclol (CBL), cannabicyclolic acid (CBLA), cannabicyclovarin (CBLV), cannabidiol (CBD), cannabidiol monomethylether (CBDM), cannabidiolic acid (CBDA), cannabidiorcol (CBDC1), cannabidiorcol (CBN-C1), cannabidivarin (CBDV), cannabidivarinic acid (CBDVA), cannabielsoic acid A (CBEA-A), cannabielsoic acid B (CBEA-B), cannabielsoin (CBE), cannabifuran (CBF), cannabigerol (CBG), cannabigerol monomethylether (CBGM), cannabigerolic Acid (CBGA), cannabigerolic acid monomethylether (CBGAM), cannabigerovarin (CBGV), cannabigerovarinic acid (CBGVA), cannabiglendol-C3, cannabinodiol (CBND), cannabinodivarin (CBV), cannabinodivarin (CBVD), cannabinol (CBN), cannabinol methylether (CBNM), cannabinol-C2 (CBN-C2), cannabinol-C4 (CBN-C4), cannabinolic acid (CBNA), cannabiripsol (CBR), cannabitriol (CBT), cannabitriolvarin (CBTV), dehydrocannabifuran (CBFD), delta-8-tetrahydrocannabinol (Δ8-THC), delta-8-tetrahydrocannabonolic acid (Δ8-THCA), delta-9-cis-tetrahydrocannabinol (CIS-THC), delta-9-tetrahydrocannabinol (Δ9-THC), delta-9-tetrahydrocannabinol-C4 (Δ9-THC-C4), delta-9-tetrahydrocannabinolic acid A (Δ9-THCA-A), delta-9-tetrahydrocannabinolic acid B (Δ9-THCA-B), delta-9-tetrahydrocannabinolic acid C4 (Δ9-THCA-C4), delta-9-tetrahydrocannabiorcol (Δ9-THCA-C1), delta-9-tetrahydrocannabiorolic acid C1 (A9-THCA-C1), delta-9-tetrahydrocannabivarin (THCV), delta-9-tetrahydrocannabivarinic acid (THCVA), lysophosphatidylinositol (LPI), N-arachidonoyl dopamine (NADA), tetrahydrocannabinol (THC), trihydroxy-delta-9-tetrahydrocannabinol (TRIOH-THC), virodhamine (OAE), or a variant thereof. The variant can comprise either a natural or synthetic variant.

### B. Solvents

In certain embodiments, the solvent competes with the dissolved analyte for active sites on the chromatography medium. In certain embodiments, the solvent is selected by considering the equilibrium between the solvent, the solutes, and the chromatography medium. In certain embodiments, the solvent is empirically determined. In certain embodiments, the solvent is chosen based on the nature of the analyte and non-analytes in the sample. In certain embodiments, the solvent system may be chosen based on the number and nature of the chemical properties of the analyte. For example, a very polar compound can require a solvent that interact strongly with the chromatography medium if the compound is to travel through the chromatography medium, e.g., a monosaccharide such as galactose is strongly retained on a silica gel plate and will not migrate in a nonpolar solvent such as benzene, whereas a polar solvent such as acetonitrile and water will displace galactose from the silica promoting the galactose to travel. For example, the retention of an analyte on silica chromatography medium generally increases, in order, with the presence of following functional groups: RH<ROCH₃<RN—(CH₃)₂<RCO₂CH₃<RNH₂<ROH<RCONH₂<RCO₂H. In certain embodiments, the purity of the solvent system can affect the performance of separation and/or concentration.

As used herein, the term “separating solvent” includes a solvent wherein one or more analytes or non-analytes travel through the chromatography medium at different rates, for example an analyte and a non-analyte travel at different rates. In certain embodiments, the separating solvent comprises any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

As used herein, the term “concentrating solvent” includes a solvent wherein a molecule, analyte or non-analyte, travel at or near the solvent front. In certain embodiments, the concentrating solvent comprises any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

### C. Strategies for Separating and Concentrating Analytes

In certain embodiments provided herein are methods for separating, concentrating, detecting, and/or quantifying a sample comprising one or more analytes comprising (a) applying a sample comprising a mixture of molecules comprising at least one analyte to a sample loading zone of a chromatography plate, (b) separating the analyte from other molecules in the mixture in a first dimension of the plate using a separating solvent, and (c) concentrating the analyte in a second dimension of the plate using a concentrating solvent. The concentrating solvent may be applied to either side of the analyte in the second dimension (FIG. 1A). In certain embodiments, the concentrating solvent is applied to one side of the second dimension to perform a first concentration step and thereafter applied to the other side of the second dimension to perform a second concentration step. Typically, in this case the analyte is concentrated toward the middle of the second dimension. Alternatively, the concentrating solvent can be applied to both sides of the second dimension simultaneously (FIG. 1B). In certain embodiments, the concentrating solvent is applied to opposite sides of the analyte such that the analyte is compressed along the second dimension. In certain embodiments, the solvent is applied by dipping the edge of the chromatography plate into a well of solvent, e.g., a beaker.

In certain embodiments, provided herein is a method comprising: (a) applying a sample comprising a mixture of molecules comprising at least one analyte to a sample loading zone of a chromatography plate, wherein the analyte is present in an amount no more than any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng, e.g., per 500 uL of mixture; (b) separating the analyte from other molecules in the mixture in a first dimension of the plate using a separating solvent; (c) concentrating the analyte in a second dimension of the plate using a concentrating solvent; and (d) detecting the concentrated analyte.

An exemplary method and article (101) are shown in FIGS. 1A and 1B. In a first step of the exemplary method, a sample comprising one or more analytes is applied to a loading zone (107). In a second step of the exemplary method, a separating solvent is applied to at least a portion of the first edge (102) of the substrate. In certain embodiments, the entire first edge of the substrate may be exposed to solvent. In certain embodiments, on a portion of the first edge of the substrate may be exposed to solvent. As the solvent travels through the chromatography medium towards the third edge (103) of the substrate, one or more components of the sample are separated in the first dimension of the substrate. Different molecules in the mixture can travel at different rates across the chromatography medium in the presence of flowing solvent depending on the chemical and physical properties of the medium, the molecules themselves, and the solvent resulting in one or more bands of molecules comprising analytes (108) and/or non-analytes (109 and/or 110). A volume of solvent may be applied such that the solvent front travels any portion of the length between the first (102) and third (103) edge of the substrate. In certain embodiments, a volume of solvent is applied such that the solvent front reaches the third edge (103) of the substrate. In certain embodiments, a volume of solvent is applied such that the solvent front does not reach the third edge (103) of the substrate. In certain embodiments, the solvent is at least partially evaporated from the chromatography medium after separation. In a third step of the exemplary method, a concentrating solvent is applied to the second edge (104) of the substrate. In certain embodiments, the solvent comprises sufficient chemical properties to prevent interaction between the analyte and the chromatography medium thereby concentrating molecules in the second dimension in the form of one or more concentrated bands of analytes (112) and/or non-analytes (111 and/or 113). A volume of solvent may be applied such that the solvent front travels any portion of the length between the second (104) and fourth (105) edge of the substrate. In certain embodiments, a volume of solvent is applied such that the solvent front reaches the fourth edge (105) of the substrate. In certain embodiments, a volume of solvent is applied such that the solvent front does not reach the fourth edge (105) of the substrate.

In certain embodiments, after separating, the analyte is separated from at least about any of 90, 80, 70, 60, 50, 40, 30, or 20% and/or no more than about any of 100, 90, 80, 70, 60, 50, 40, or 30% of the non-analyte molecules in the mixture, for example the analyte is separated from between about 100% and 20% of the non-analytes, preferably between about 100% and 50%, more preferably between 100% and 80%.

In certain embodiments, after concentrating, the one or more analyte is concentrated to an area to an area of less than about any of 50%, 45%, 40%, 35%, 30%, 25%, 20%, 15%, 10%, 5%, 1%, 0.5%, or 0.1% of the sample loading zone, for example less than about 25% of the sample loading zone.

In certain embodiments, at least a portion of the solvent is removed from the substrate before applying a subsequent solvent. In certain embodiments, the entire chromatography medium is dried of solvent before applying the subsequent solvent. In certain cases, wherein a covering layer is present, at least a portion of the chromatography medium exposed to external atmosphere is dried of solvent before applying the subsequent solvent. In certain embodiments, the solvent is removed by evaporation. In certain embodiments, the evaporation is accelerated by heating. In certain embodiments, the evaporation is slowed by cooling. In certain embodiments, the evaporation is modulated by air flow modulation, e.g., a fan or a pump.

In certain embodiments, the evaporated solvent is released to atmosphere. In certain embodiments, the evaporated solvent is captured using any suitable method, for example passing the solvent through activated carbon, a chamber at reduced temperature, e.g., cryogenic, and/or a chamber of increased pressure. In certain embodiments, the evaporated solvent is combusted, and the combustion product is released to atmosphere. In certain embodiments, the evaporated solvent is combusted, and the combustion product is captured using any suitable method, for example passing the combustion product through an activated carbon.

In certain embodiments provided herein are a method for quantify a sample comprising one or more analytes comprising (a) applying a sample comprising a mixture of molecules comprising at least one analyte to a sample loading zone of a chromatography plate, (b) separating the analyte from other molecules in the mixture in a first dimension of the plate using a separating solvent, and (c) concentrating the analyte in a second dimension of the plate using a concentrating solvent, wherein the chromatography plate comprises one or more barriers free of chromatography medium wherein liquid phase cannot travel and/or one or more gates. In certain embodiments, the one or more barriers prevent one or more of the non-analyte molecules in the mixture from traveling past the barrier in the second dimension, whereby one or more non-analytes are not concentrated in the second dimension. In certain embodiments, the one or more gates enable one or more analytes to travel further in the second dimension than one or more non-analytes.

In certain embodiments, the barrier is produced during manufacture. In certain embodiments the barrier is generated by the user before or after separating.

An exemplary method and article are shown in FIG. 2. In a first step of the exemplary method (FIG. 2A), a sample comprising one or more analytes is applied to a loading zone (209). In a second step of the exemplary method, a separating solvent is applied to at least a portion of the first edge (202) of the substrate. As the solvent travels through the chromatography medium towards the third edge (203) of the substrate, one or more components of the sample are separated in the first dimension of the substrate. Different molecules in the mixture can travel at different rates across the chromatography medium in the presence of flowing solvent depending on the chemical and physical properties of the medium, the molecules themselves, and the solvent resulting in one or more bands of molecules comprising analytes (210) and/or non-analytes. A volume of solvent may be applied such that the solvent front travels any portion of the length between the first (202) and third (203) edge of the substrate. In certain embodiments, a volume of solvent is applied such that the solvent front reaches the third edge (203) of the substrate. In certain embodiments, a volume of solvent is applied such that the solvent front does not reach the third edge (203) of the substrate. In certain embodiments, the solvent is at least partially evaporated from the chromatography medium after separation. In certain embodiments of the exemplary method, the barriers (206 and 207) are produced during manufacturing. In certain embodiments of the exemplary method, the barriers (206 and 207) are generated by the user prior to separation. In certain embodiments of the exemplary method, the barriers (206 and 207) are generated by the user after separation. In a third step of the exemplary method, a concentrating solvent is applied to the second edge (204) of the substrate. In certain embodiments, the solvent comprises sufficient chemical properties to prevent interaction between the analyte and the chromatography medium thereby concentrating molecules in the second dimension in the form of a concentrated band at the solvent front. A volume of solvent may be applied such that the solvent front travels any portion of the length between the second (204) and fourth (205) edge of the substrate. In certain embodiments, a volume of solvent is applied such that the solvent front reaches the fourth edge (205) of the substrate. In certain embodiments, a volume of solvent is applied such that the solvent front does not reach the fourth edge (205) of the substrate. In certain embodiments, the one or more barriers (206 and 207) prevent one or more non-analytes from passing through the barrier. In certain embodiments, the one or more gates (208) allows the one or more analytes (211) to travel further than the non-analytes. In certain embodiments, the solvent is at least partially evaporated from the chromatography medium after concentration. In an optional fourth step of the exemplary method (FIG. 2B), a concentrating solvent can be applied to either the first (202) or the third (203) edge of the substrate, whereby the one or more analytes and/or non-analytes are further concentrated in the first dimension.

In certain embodiments, the concentrating solvent can be applied to either the entire length of the first (202) or third (203) edge of the substrate or to a portion thereof. In certain embodiments (FIG. 3A), the article can comprise additional barrier elements to generate fluidically disconnected regions (311, 312, and 313). In certain embodiments, the additional barrier elements are generated after the separation step. In certain embodiments, the concentrating solvent can be applied to either the entire length of the second edge (304) of the substrate or to a portion thereof. In certain embodiments, the concentrating solvent is only 20) applied to the portion of the second edge (304) of the substrate fluidically connected to the one or more analyte (310). In certain embodiments (FIG. 3B), following concentrating in the second a concentrating solvent can be applied to either the first (302) or the third (303) edge of the substrate to further concentrate the one or more analytes and/or non-analytes in the first dimension. In certain embodiments, the concentrating solvent is only applied to the portion of the first (302) or third (303) edge of the substrate fluidically connected to the one or more analyte (310).

In certain embodiments, after concentrating the analyte, the analyte can be further separated in a first dimension of the substrate by applying a separating solvent to at least a portion of the first edge of the substrate. In certain embodiments, a subsequent concentration step can be performed in the second dimension by applying a concentrating solvent to a least a portion of second edge of the substrate. Exemplary articles for performing this method are shown in FIG. 4. In certain embodiments, a subsequent concentration step can be performed in the first dimension by applying a concentrating solvent to at least a portion of the first or the fourth edge of the substrate.

In certain embodiments, the solvent separating solvent is applied to the corresponding edge of the chromatography medium by dipping the corresponding edge into a solvent bath comprising the separating solvent. In certain embodiments, after separation, the concentrating solvent is applied to the corresponding edge of the chromatography medium by rotating the plate and dipping the corresponding edge into a solvent bath comprising the concentrating solvent.

In certain embodiments, an area of chromatography medium comprising an analyte and/or non analyte may be recovered by a user. In certain embodiments, the analyte and/or non-analyte may be recovered by scraping of the substrate and collecting the chromatography medium comprising the analyte and/or non-analyte.

In certain embodiments, a sample can be concentrated in the first dimension prior to separation. The sample concentration step can be performed by applying a concentrating solvent to either side of the first dimension either sequentially or simultaneously. Additionally or alternatively, a sample can be concentrated in the second dimension prior to separation. The sample concentration step can be performed by applying a concentrating solvent to either side of the second dimension either sequentially or simultaneously. In certain embodiments, concentrating the sample prior to separation can be advantageous to improve the quality of separation and/or sensitivity for downstream detection and analyte quantification.

### D. Detection and Quantification

In certain embodiments, the analyte is colored and/or fluorescent and may be detected by a suitable detector.

In certain embodiments wherein the chromatography medium comprises a fluorescent molecule, the fluorescent molecule is excited by an excitation light source comprising a certain wavelength light. In certain embodiments, molecules that absorb the wavelength of light can prevent the chromatography medium from exciting resulting in the appearance of dark spots on the fluorescing chromatography medium. The position, darkness, and size of the spots on the chromatography medium can correspond to the identity and amount of molecule in the spot.

Any suitable detector can be used. In certain embodiments, detecting the analyte comprises taking one or more images of the chromatography plate with a detector, preferably a camera. In certain embodiments, the camera configured to image at least any of 25%, 30%, 35%, 40%, 45%, 50%, 55%, 60%, 65%, 70%, 65%, 80%, 85%, 90%, 95%, or 100% of the surface area of the chromatography plate, preferably 25-75%, more preferably 40-60%.

In certain embodiments, after separation and concentration, one or more indicator, e.g., dyes, may be applied to the chromatography medium by dipping, wiping, brushing, and/or spraying. In certain embodiments, after separation and concentration, the analyte may be detected using a detector. In certain embodiments, the indicator reacts with the analyte rendering it visible and/or fluorescent. In certain embodiments, the indicator is reacted with the analyte during sample preparation. In certain embodiments, the indicator is reacted with the analyte after sample loading. In certain embodiments, the indicator is reacted with the analyte after one or more separation and/or concentration steps. In certain embodiments, the indicator is a liquid or a vapor. In certain embodiments, the reaction between the indicator and the analyte can be accelerated by heating. In certain embodiments, the detector is configured to measure the property of one or more indicator including but not limited to iodine, p-anisaldehyde, vanillin, permanganate, phosphomolybdic acid, iron (III) chloride, bromocresol green), o-Dianisidine bis (diazotized) zinc double salt, 2,5-Dimethoxy-4-([4-nitrophenyl]azo)benzenediazonium chloride hemi-zinc chloride salt, 5-chloro-2-methoxybenzenediazonium chloride hemi (zinc chloride) salt, (1S,2S)-2-(naphthalene-2,3-dicarboximido)cyclohexanecarboxylic acid, (1R,2R)-2-(naphthalene-2,3-dicarboximido)cyclohexanecarboxylic acid, or a suitable alternative. In certain embodiments, the method further comprises washing the chromatography plate with a solvent after applying the indicator to rinse away any excess indicator. This solvent can be any suitable solvent as disclosed herein.

In certain embodiments, the identity of one or more analytes may be elucidated by the relative position of the analyte on the medium compared to the loading zone after one or more separation and/or concentration steps.

In certain embodiments, the identity of one or more analytes may be elucidated by the respective optical properties of the one or more analytes. In certain embodiments, the identify of one or more analytes may be elucidated by the analyte's reaction with a dye or indicator of interest.

In certain embodiments, the amount of one or more analytes may be quantified. In certain embodiments, the one or more analytes may be quantified by the size and intensity of the spot comprising the one or more analytes. In certain embodiments a standard comprising one or more known amounts of analyte is used for comparative analysis to an unknown amount of analyte.

In certain embodiments, the quantity of one or more analytes can be determined by comparing the signal after detection of the one or more analytes as compared to the signal of one or more calibrants. In a non-limiting example, unknown amounts of the analyte of interest on the plate can be compared to a known amount of calibrant and the resulting signal intensity is measured. The intensity of the signal for the calibrant can be integrated over time, and a calibration curve can be generated comprising the signal intensity with respect to concentration. The signal of the unknown sample can then be compared to the calibration curve, and the unknown concentration is determined.

In certain embodiments, the method comprises adding a calibrant to, but not in contact with, the sample loading zone and measuring the calibrant, wherein the calibrant separates along the first dimension after applying the separating solvent. Optionally, the calibrant can further concentrate along the second dimension after applying the concentrating solvent. Alternatively, the method comprises adding a calibrant to the chromatography plate prior to running the sample (the calibrant may be added during manufacturing or by the user), wherein the calibrant is positioned opposite of the sample loading zone and the calibrant is not contacted with either the separating and/or concentrating solvent while performing the method.

Any suitable number of calibrants can be placed on the substrate, such as no more than any of 10, 9, 8, 7, 6, 5, 4, 3, 2, or 1 different concentrations of an analyte to be quantified.

Typically, the methods disclosed herein are capable of achieving unprecedented levels of sensitivity as compared to other thin layer chromatography methods due to one or both of loading large sample volumes as well as concentrating of the analyte after separation. In certain embodiments, the method is capable of detecting at least any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng and/or not more than any of any of 10 ng, 20 ng, 30 ng, 40 ng, 50 ng, 60 ng, 70 ng, 80 ng, 90 ng, 100 ng, 500 ng, 1,000 ng, 2,500 ng, 5,000 ng, or 10,000 ng of analyte per 500 uL of mixture, for example 0.1-10,000 ng of analyte per 500 uL of mixture, preferably 0.1-2,000 ng of analyte per 500 uL of mixture.

### V. Kits

As used herein, the term “kit” refers to a collection of items intended for use together. The kit can optionally include a reference agent and/or instructions for use thereof. A kit can further include a shipping container adapted to hold a container, such as a vial, that contains a solvent composition as disclosed herein. A kit can include a container that contains within it the collection of items.

In certain embodiments, a kit comprises any of the described articles and one or more solvents required to perform the described methods. Any suitable number of solvents can be added in the kit, typically two solvents, e.g., a separating solvent and a concentrating solvent.

In certain embodiments, a third solvent is included in the kit, e.g., a washing solvent to wash away excess indicator after staining. In certain embodiments, a kit further comprises one or more indicator as described above. In certain embodiments, a kit further comprises a system as described above.

### EXEMPLARY EMBODIMENTS

A method comprising: (a) applying a sample comprising a mixture of molecules comprising at least one analyte to a sample loading zone of a chromatography plate; (b) separating the analyte from other molecules in the mixture in a first dimension of the plate using a separating solvent; and (c) concentrating the analyte in a second dimension of the plate using a concentrating solvent.

The method of embodiment 1, wherein the analyte is present in the mixture at a concentration of no more than about any of 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% and/or at least about any of 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, or 0.005% weight of mixture.

The method of embodiment 1 or embodiment 2, wherein the analyte is present in the mixture at a concentration of at least any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng and/or not more than any of any of 10 ng, 20 ng, 30 ng, 40 ng, 50 ng, 60 ng, 70 ng, 80 ng, 90 ng, 100 ng, 500 ng, 1,000 ng, 2,500 ng, 5,000 ng, or 10,000 ng of analyte per 500 uL of mixture, for example 0.1-10,000 ng of analyte per 500 uL of mixture, preferably 0.1-2,000 ng of analyte per 500 uL of mixture.

The method of any one of embodiments 1-3, wherein the sample comprises a biological sample.

The method of embodiment 4, wherein the biological sample comprises saliva, sputum, blood, plasma, serum, urine, stool, cerebral spinal fluid, bile fluid, lymph fluid.

The method of any one of embodiments 1-3, wherein the sample comprises an environmental sample comprising a soil sample, a water sample, or an air sample.

The method of any one of embodiments 1-6, wherein the analyte comprises a controlled substance.

The method of embodiment 7, wherein the controlled substance comprises a cannabinoid.

The method of embodiment 8, wherein the cannabinoid is 10-ethoxy-9-hydroxy-delta-6a-tetrahydrocannabinol, 10-oxo-delta-6a-tetrahydrocannabinol (OTCH), 2-arachidonoylglycerol (2AG), 2-arachidonyl glyceryl ether, 8,9-dihydroxy-delta-6a-tetrahydrocannabinol, anandamide (AEA), cannabichromanon (CBCN), cannabichromene (CBC), cannabichromenevarin (CBCV), cannabichromenic Acid (CBCA), cannabichromevarinic acid (CBCVA), cannabicitran (CBT-C), cannabicyclol (CBL), cannabicyclolic acid (CBLA), cannabicyclovarin (CBLV), cannabidiol (CBD), cannabidiol monomethylether (CBDM), cannabidiolic acid (CBDA), cannabidiorcol (CBDC1), cannabidiorcol (CBN-C1), cannabidivarin (CBDV), cannabidivarinic acid (CBDVA), cannabielsoic acid A (CBEA-A), cannabielsoic acid B (CBEA-B), cannabielsoin (CBE), cannabifuran (CBF), cannabigerol (CBG), cannabigerol monomethylether (CBGM), cannabigerolic Acid (CBGA), cannabigerolic acid monomethylether (CBGAM), cannabigerovarin (CBGV), cannabigerovarinic acid (CBGVA), cannabiglendol-C3, cannabinodiol (CBND), cannabinodivarin (CBV), cannabinodivarin (CBVD), cannabinol (CBN), cannabinol methylether (CBNM), cannabinol-C2 (CBN-C2), cannabinol-C4 (CBN-C4), cannabinolic acid (CBNA), cannabiripsol (CBR), cannabitriol (CBT), cannabitriolvarin (CBTV), dehydrocannabifuran (CBFD), delta-8-tetrahydrocannabinol (Δ8-THC), delta-8-tetrahydrocannabinolic acid (Δ8-THCA), delta-9-cis-tetrahydrocannabinol (CIS-THC), delta-9-tetrahydrocannabinol (Δ9-THC), delta-9-tetrahydrocannabinol-C4 (Δ9-THC-C4), delta-9-tetrahydrocannabinolic acid A (Δ9-THCA-A), delta-9-tetrahydrocannabinolic acid B (Δ9-THCA-B), delta-9-tetrahydrocannabinolic acid C4 (Δ9-THCA-C4), delta-9-tetrahydrocannabiorcol (Δ9-THCA-C1), delta-9-tetrahydrocannabiorolic acid C1 (Δ9-THCA-C1), delta-9-tetrahydrocannabivarin (THCV), delta-9-tetrahydrocannabivarinic acid (THCVA), lysophosphatidylinositol (LPI), N-arachidonoyl dopamine (NADA), tetrahydrocannabinol (THC), trihydroxy-delta-9-tetrahydrocannabinol (TRIOH-THC), virodhamine (OAE), or a variant thereof.

The method of any one of embodiments 1-9, wherein the chromatography plate comprises: (i) a solid substrate comprising a surface and four edges, wherein a first edge is opposite to a third edge and a second edge is opposite to a fourth edge; (ii) a chromatography medium on the substrate; (iii) a separation zone oriented along the first dimension of the plate, wherein the first dimension is directed between the first and the third edge of the substrate; (iv) a concentration zone oriented along the second dimension of the plate, wherein the second dimension is directed between the second and fourth edge of the substrate; and (v) a sample loading zone positioned near the anterior end of the first and second dimensions adjacent to the first and second edge of the substrate.

The method of any one of embodiments 1-10, wherein the sample loading zone has a capacity between about 1 uL and about 2 mL, preferably about 100 uL to about 1 mL, more preferably about 250 uL to about 750 uL, even more preferably about 400 uL to about 600 uL.

The method of any one of embodiments 1-11, wherein the sample loading zone has an elongated shape comprising a long axis between about 2.5 and about 50 mm long.

The method of any one of embodiments 1-12, wherein, after separating, the analyte is separated from at least 50% of the non-analyte molecules in the mixture.

The method of any one of embodiments 1-13, wherein the analyte is concentrated to an area to an area of less than about any of 50%, 45%, 40%, 35%, 30%, 25%, 20%, 15%, 10%, 5%, 1%, 0.5%, or 0.1% of the sample loading zone.

The method of any one of embodiments 1-14, wherein the sample loading zone comprises a separate chromatography medium from the separating zone and the concentrating zone whereby the sample concentrates at the boundary between the two mediums.

The method of any one of embodiments 1-15, wherein the first dimension is between about 0.5 cm to about 10 cm long.

The method of any one of embodiments 1-16, wherein the separating solvent comprises any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

The method of any one of embodiments 1-17, wherein the concentrating solvent comprises of any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

The method of any one of embodiments 1-18, further comprising: d) detecting the analyte.

The method of embodiment 19, wherein detecting the analyte comprises measuring at least one optical property of the analyte.

The method of embodiment 20, wherein the optical property is absorbance, fluorescence, reflectance, or optical rotation.

The method of any one of embodiments 19-21, wherein detecting the analyte comprises taking one or more images of the chromatography plate with a detector, preferably a camera.

The method of any one of embodiments 1-22, further comprising, after concentrating, applying an indicator, e.g., dye, to the chromatography medium.

The method of embodiment 23, wherein the indicator comprises of any one of iodine, p-anisaldehyde, vanillin, permanganate, phosphomolybdic acid, iron (III) chloride, bromocresol green), o-Dianisidine bis(diazotized) zinc double salt, 2,5-Dimethoxy-4-([4-nitrophenyl]azo)benzenediazonium chloride hemi-zinc chloride salt, 5-chloro-2-methoxybenzenediazonium chloride hemi(zinc chloride) salt, (1S,2S)-2-(naphthalene-2,3-dicarboximido)cyclohexanecarboxylic acid, (1R,2R)-2-(naphthalene-2,3-dicarboximido)cyclohexanecarboxylic acid, or a suitable alternative.

The method of any one of embodiments 1-24, further comprising: adding a calibrant adjacent to but not in contact with the sample loading zone and measuring the calibrant, wherein the calibrant separates along the first dimension after applying the separating solvent, or measuring a calibrant added to the chromatography plate prior to running the sample, wherein the calibrant is positioned opposite of the sample loading zone and the calibrant is not contacted with either the separating and/or concentrating solvent while performing the method.

The method of embodiment 25, wherein the concentration of the analyte is determined using the calibrant as a reference standard.

The method of any one of embodiments 1-26, further comprising: before or after separating, creating a barrier by removing at least a portion of the medium from the substrate to prevent one or more of the non-analyte molecules in the mixture from traveling past the barrier in the second dimension, whereby one or more non-analyte is not concentrated in the second dimension.

The method of embodiment 27, wherein the medium is removed during manufacturing of the plate, before use, or during use.

The method of embodiment 28, wherein the medium is removed by etching, scoring, milling, or embossing.

The method of any one of embodiments 1-29, further comprising: (1) after concentrating, applying a concentrating solvent at either the first or third edge of the substrate, whereby the analyte is further concentrated.

The method of any one of embodiments 1-30, further comprising: (1) after concentrating the analyte, (i) further separating the analyte in a first dimension by applying a solvent to the first edge of the substrate; and (ii) concentrating the analyte in a second dimension by applying a concentrating solvent to the second edge of the substrate.

The method of embodiment 31, further comprising: (2) applying a concentrating solvent to either the anterior or posterior end of the first dimension of the plate.

The method of any one of embodiments 1-32, wherein the second dimension is at an angle between about 45 degrees and about 135 degrees, about 75 degrees and about 105 degrees, about 80 degrees and about 100 degrees, or about 85 degrees and about 95 degrees from the first dimension.

The method of embodiment 33, wherein the second dimension is substantially orthogonal to the first dimension.

The method of any one of embodiments 1-34, further comprising, after concentrating, heating a portion of the plate to evaporate the solvent in a third dimension, wherein the analyte is further concentrated at an evaporative front.

The method of any one of embodiments 1-35, wherein at least a portion of the solvent is removed from the substrate before applying a subsequent solvent.

The method of embodiment 36, wherein the solvent is removed by evaporation.

The method of embodiment 37, wherein the evaporation is accelerated through heating or through increased air flow.

The method of embodiment 37 or embodiment 38, further comprising preventing release of the evaporated solvent to atmosphere.

The method of embodiment 39, wherein evaporated solvent is captured using activated carbon, reduced temperature, e.g., cryogenic, increased pressure, or a suitable alternative.

The method of embodiment 39, wherein evaporated solvent is combusted.

The method of any one of embodiments 1-41, further comprising controlling the temperature of the plate.

The method of any one of embodiments 1-42, wherein at least one covering layer is in contact with and covers at least a portion of the substrate surface.

The method of any one of embodiments 1-43, wherein the concentrated analyte is extracted from the chromatography medium.

The method of any one of embodiments 1-44, performed with an article of manufacture comprising: (I) a solid substrate; and (II) chromatography medium on a surface of the substrate; wherein at least a portion of the medium is removed to expose a surface of the substrate thereby forming a barrier across which liquid phase cannot travel, and, optionally, (III) one or more calibrants placed on the chromatography medium.

The method of any one of embodiments 1-45, wherein the method is capable of detecting at least any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng and/or not more than any of any of 10 ng, 20 ng, 30 ng, 40 ng, 50 ng, 60 ng, 70 ng, 80 ng, 90 ng, 100 ng, 500 ng, 1,000 ng, 2,500 ng, 5,000 ng, or 10,000 ng of analyte per 500 uL of mixture, for example 0.1-10,000 ng of analyte per 500 uL of mixture, preferably 0.1-2,000 ng of analyte per 500 uL of mixture.

An article of manufacture comprising: (a) a solid substrate comprising a surface and four edges, wherein a first edge is opposite to a third edge and a second edge is opposite to a fourth edge; (b) chromatography medium on the surface of the substrate through which liquid phase can travel; and (c) one or more barriers, the barrier comprising an area of substrate reduced in chromatography medium across which a liquid phase cannot travel.

The article of embodiment 46, wherein the one or more barriers span at least a portion of the length between the first to the third edge of the substrate.

The article of embodiment 47 or embodiment 48, wherein the barrier is offset from the second or fourth edge of the substrate by at least 1 cm.

The article of any one of embodiments 47-49, comprising two barriers and a gate, the gate comprising an area of substrate where chromatography medium remains and liquid phase can travel, wherein the first barrier is in contact with the first edge of the substrate; the second barrier is in contact with the third edge of the substrate; and a gate is positioned between the first and second barrier.

The article of any one of embodiments 47-50, wherein at least a portion of the chromatography medium is surrounded by a barrier resulting in two fluidically isolated areas of chromatography medium, optionally, wherein one or more calibrants is place in one of the fluidically isolated areas of the chromatography medium.

The article of embodiment 51, further comprising a second barrier thereby resulting in three fluidically isolated areas of chromatography medium.

The article of embodiment 52, further comprising three fluidically isolated areas of chromatography medium wherein the first barrier extends from the end of the first barrier opposite the first edge of the substrate to either the second or fourth edge of the substrate; and the second barrier extends from the end of the second barrier opposite the third edge of the substrate to either the second or fourth edge of the substrate.

The article of any one of embodiments 47-53, wherein the substrate comprises any one of glass, quartz, metal, aluminum, and plastic.

The article of any one of embodiments 47-54, wherein the substrate is at least 2.5 by 2.5 mm.

The article of any one of embodiments 47-55, wherein the chromatography medium comprises any one of silica, alumina, cellulose, or polyamide.

The article of any one of embodiments 47-56, wherein the chromatography medium comprises one or more C2, C8, C10, C18, phenol, amine, or chiral chemical modifications.

The article of any one of embodiments 47-57, wherein the chromatography medium further comprises a fluorescent molecule whereby the chromatography medium fluoresces upon exposure to electromagnetic radiation.

The article of any one of embodiments 47-58, wherein the article comprises: (i) a separation zone oriented along a first dimension of the substrate, wherein the first dimension is directed between the first and third edge of the substrate; (ii) a concentration zone oriented along a second dimension of the substrate, wherein the second dimension is directed between the second and fourth edge of the substrate; and (iii) a sample loading zone positioned near the anterior end of the first and second dimensions adjacent to the first and second edge of the substrate.

The article of embodiment 59, wherein the separation zone is at least 2.5 cm long.

The article of embodiment 59, wherein the separation zone is no more than 99% of the substrate length.

The article of embodiment 59, wherein the separation zone comprises two or more subzones, wherein each subzone comprises a different chromatography medium.

The article of embodiment 59, wherein the sample loading zone comprises an elongated shape.

The article of embodiment 63, wherein the elongated sample loading zone comprises a short axis oriented along the first dimension of the substrate and a long axis oriented along the second dimension of the substrate.

The article of embodiment 64, where the long axis of the sample loading zone is about 10 times as long as the short axis of the sample loading zone.

The article of embodiment 59, wherein the sample loading zone comprises at most 40% of the height and 95% of the width of the substrate.

The article of embodiment 59, wherein the sample loading zone comprises a separate chromatography medium from the separating zone and the concentrating zone whereby the sample concentrates at the boundary between the two mediums.

The article of any one of embodiments 47-67, further comprising a covering layer in contact with at least a portion of the chromatography medium.

The article of embodiment 68, wherein the covering layer comprises any one of glass, quartz, metal, epoxy, or plastic.

A method of making an article of any one of embodiments 47-69, comprising: (a) obtaining a substrate; (b) coating the substrate with chromatography medium; and (c) removing at least a portion of chromatography medium from the substrate, thereby forming a barrier free of chromatography medium across which a liquid phase cannot travel.

The method of embodiment 70, wherein the chromatography medium is removed by etching, scoring, milling, or embossing.

The method of embodiment 70 or embodiment 71, further comprising a calibrant adjacent to but not in contact with the sample loading zone.

A method of making an article of any one of embodiments 47-69, comprising: (a) obtaining a substrate; (b) masking at least a portion of the substrate; (c) coating the substrate with chromatography medium; and (d) removing the mask and any coated chromatography medium, thereby forming a barrier free of chromatography medium across which a liquid phase cannot travel.

The method of embodiment 73, further comprising a calibrant adjacent to but not in contact with the sample loading zone.

A kit comprising: (a) an article of any one of embodiments 47-69; and (b) at least one solvent, preferably two solvents.

The kit of embodiment 75, wherein the solvent comprises any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

The kit of embodiment 75 or embodiment 76, further comprising: (c) an indicator, e.g., dye.

The kit of embodiment 75, where in the indicator comprises of any one of iodine, p-anisaldehyde, vanillin, permanganate, phosphomolybdic acid, iron (III) chloride, bromocresol green), o-Dianisidine bis(diazotized) zinc double salt, 2,5-Dimethoxy-4-([4-nitrophenyl]azo)benzenediazonium chloride hemi-zinc chloride salt, 5-chloro-2-methoxybenzenediazonium chloride hemi(zinc chloride) salt, (1S,2S)-2-(naphthalene-2,3-dicarboximido)cyclohexanecarboxylic acid, (1R,2R)-2-(naphthalene-2,3-dicarboximido)cyclohexanecarboxylic acid, or a suitable alternative.

A system comprising: (a) a receiving area for a chromatography plate; (b) at least one solvent chamber configured such that, when the chromatography cartridge is inserted into the receiving area, the solvent chamber is in fluid communication with at least a portion of the chromatography medium, optionally, wherein the solvent chamber is in fluid communication with one or more sources of solvent; and (c) a detector.

The system of embodiment 79, wherein the receiving area is oriented horizontally.

The system of embodiment 79, wherein the receiving is oriented vertically.

The system of any one of embodiments 79-81, wherein the chromatography plate comprises an article of embodiment 47-69.

The system of any one of embodiments 79-82, wherein the system is configured to receive the chromatography plate.

The system of embodiment 79-83, wherein the solvent chamber comprises a material comprising any one of glass, metal, PTFE, PVDF, ECTFE, PCTFE, FEP, ETFE, PEEK, PPS, or a suitable alternative.

The system of embodiment 79-84, wherein the solvent chamber comprises a sealing element to reduce solvent evaporation.

The system of embodiment 85, wherein the sealing element can be removed and reattached or replaced to allow solvent additions.

The system of any one of embodiments 79-86, wherein the detector is an optical detector, preferably a camera configured to image at least any of 25%, 30%, 35%, 40%, 45%, 50%, 55%, 60%, 65%, 70%, 65%, 80%, 85%, 90%, 95%, or 100% of the surface area of the chromatography plate, preferably 25-75%, more preferably 40-60%.

The system of any one of embodiments 79-87, further comprising a covering layer that when in contact with the receiving area produces a sealed chamber.

The system of any one of embodiments 79-88, further comprising a temperature control element.

The system of any one of embodiments 79-89, further comprising a component to accelerate evaporation of solvent from the chromatography medium, e.g., a fan, a source of compress air, and/or a heater element, configured accelerate the rate of evaporation, wherein the component is configured to activate after a sample loading step, a separation step, a concentration step, and/or an indicator application step.

A kit comprising: (a) an article of any one of embodiments 47-69; and (b) a system of any one of embodiments 79-90.

A method comprising: (a) applying a sample comprising a mixture of molecules comprising at least one analyte to a sample loading zone of a chromatography plate; (b) separating the analyte from other molecules in the mixture in a first dimension of the plate using a separating solvent; and (c) concentrating the analyte in a second dimension of the plate using a concentrating solvent, wherein the concentrating solvent is applied to both sides of the analyte such that the analyte is concentrated towards the middle of the second dimension.

The method of embodiment 92, wherein the analyte is present in the mixture at a concentration of no more than about any of 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% and/or at least about any of 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, or 0.005% weight of mixture.

The method of embodiment 92 or embodiment 93, wherein the analyte is present in the mixture at a concentrate of no more than about any of 1 ng, 0.9 ng, 0.8 ng, 0.7 ng, 0.6 ng, 0.5 ng, 0.4 ng, 0.3 ng, 0.2 ng, 0.1 ng, 0.09 ng, 0.08 ng, 0.07 ng, 0.06 ng, 0.05 ng, 0.04 ng, 0.03ng, 0.02 ng, or 0.01 ng, or 0.005 ng and/or at least about any of 0.9 ng, 0.8 ng, 0.7 ng, 0.6 ng, 0.5 ng, 0.4 ng, 0.3 ng, 0.2 ng, 0.1 ng, 0.09 ng, 0.08 ng, 0.07 ng, 0.06 ng, 0.05 ng, 0.04 ng, 0.03 ng, 0.02 ng, 0.01 ng, 0.005 ng, or 0.001 ng per 500 uL.

The method of any one of embodiments 92-94, wherein the sample comprises a biological sample.

The method of embodiment 95, wherein the biological sample comprises saliva, sputum, blood, plasma, serum, urine, stool, cerebral spinal fluid, bile fluid, lymph fluid.

The method of any one of embodiments 92-94, wherein the sample comprises an environmental sample comprising a soil sample, a water sample, or an air sample.

The method of any one of embodiments 92-97, wherein the analyte comprises a controlled substance.

The method of embodiment 98, wherein the controlled substance comprises a cannabinoid.

The method of embodiment 99, wherein the cannabinoid is 10-ethoxy-9-hydroxy-delta-6a-tetrahydrocannabinol, 10-oxo-delta-6a-tetrahydrocannabinol (OTCH), 2-arachidonoylglycerol (2AG), 2-arachidonyl glyceryl ether, 8,9-dihydroxy-delta-6a-tetrahydrocannabinol, anandamide (AEA), cannabichromanon (CBCN), cannabichromene (CBC), cannabichromenevarin (CBCV), cannabichromenic Acid (CBCA), cannabichromevarinic acid (CBCVA), cannabicitran (CBT-C), cannabicyclol (CBL), cannabicyclolic acid (CBLA), cannabicyclovarin (CBLV), cannabidiol (CBD), cannabidiol monomethylether (CBDM), cannabidiolic acid (CBDA), cannabidiorcol (CBDC1), cannabidiorcol (CBN-C1), cannabidivarin (CBDV), cannabidivarinic acid (CBDVA), cannabielsoic acid A (CBEA-A), cannabielsoic acid B (CBEA-B), cannabielsoin (CBE), cannabifuran (CBF), cannabigerol (CBG), cannabigerol monomethylether (CBGM), cannabigerolic Acid (CBGA), cannabigerolic acid monomethylether (CBGAM), cannabigerovarin (CBGV), cannabigerovarinic acid (CBGVA), cannabiglendol-C3, cannabinodiol (CBND), cannabinodivarin (CBV), cannabinodivarin (CBVD), cannabinol (CBN), cannabinol methylether (CBNM), cannabinol-C2 (CBN-C2), cannabinol-C4 (CBN-C4), cannabinolic acid (CBNA), cannabiripsol (CBR), cannabitriol (CBT), cannabitriolvarin (CBTV), dehydrocannabifuran (CBFD), delta-8-tetrahydrocannabinol (Δ8-THC), delta-8-tetrahydrocannabinolic acid (Δ8-THCA), delta-9-cis-tetrahydrocannabinol (CIS-THC), delta-9-tetrahydrocannabinol (Δ9-THC), delta-9-tetrahydrocannabinol-C4 (Δ9-THC-C4), delta-9-tetrahydrocannabinolic acid A (Δ9-THCA-A), delta-9-tetrahydrocannabinolic acid B (Δ9-THCA-B), delta-9-tetrahydrocannabinolic acid C4 (Δ9-THCA-C4), delta-9-tetrahydrocannabiorcol (Δ9-THCA-C1), delta-9-tetrahydrocannabiorolic acid C1 (A9-THCA-C1), delta-9-tetrahydrocannabivarin (THCV), delta-9-tetrahydrocannabivarinic acid (THCVA), lysophosphatidylinositol (LPI), N-arachidonoyl dopamine (NADA), tetrahydrocannabinol (THC), trihydroxy-delta-9-tetrahydrocannabinol (TRIOH-THC), virodhamine (OAE), or a variant thereof.

The method of any one of embodiments 92-100, wherein the chromatography plate comprises: (i) a solid substrate comprising a surface and four edges, wherein a first edge is opposite to a third edge and a second edge is opposite to a fourth edge; (ii) a chromatography medium on the substrate; (iii) a separation zone oriented along the first dimension of the plate, wherein the first dimension is directed between the first and the third edge of the substrate; and (iv) a concentration zone oriented along the second dimension of the plate, wherein the second dimension is directed between the second and fourth edge of the substrate; and (v) a sample loading zone positioned near the anterior end of the first and second dimensions adjacent to the first and second edge of the substrate.

The method of any one of embodiments 92-101, wherein the sample loading zone has a capacity between about 1 ul and about 2 mL, preferably about 100 uL to about 1 mL, more preferably about 250 uL to about 750 uL, even more preferably about 400 uL to about 600 uL.

The method of any one of embodiments 92-102, wherein the sample loading zone has an elongated shape comprising a long axis between about 2.5 and about 50 mm long.

The method of any one of embodiments 92-103, wherein, after separating, the analyte is separated from at least 50% of the non-analyte molecules in the mixture.

The method of any one of embodiments 92-104, wherein the analyte is concentrated to an area to an area of less than about any of 50%, 45%, 40%, 35%, 30%, 25%, 20%, 15%, 10%, 5%, 1%, 0.5%, or 0.1% of the sample loading zone.

The method of any one of embodiments 92-105, wherein the sample loading zone comprises a separate chromatography medium from the separating zone and the concentrating zone whereby the sample concentrates at the boundary between the two mediums.

The method of any one of embodiments 92-106, wherein the first dimension is between about 0.5 cm to about 10 cm long.

The method of any one of embodiments 92-107, wherein the separating solvent comprises any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

The method of any one of embodiments 92-108, wherein the concentrating solvent comprises of any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

The method of any one of embodiments 92-109, further comprising: (d) detecting the analyte.

The method of embodiment 110, wherein detecting the analyte comprises measuring at least one optical property of the analyte.

The method of embodiment 111, wherein the optical property is absorbance, fluorescence, reflectance, or optical rotation.

The method of any one of embodiments 110-112, wherein detecting the analyte comprises taking one or more images of the chromatography plate with a detector, preferably a camera.

The method of any one of embodiments 92-113, further comprising, after concentrating, applying an indicator, e.g., dye, to the chromatography medium.

The method of embodiment 114, wherein the indicator comprises of any one of iodine, p-anisaldehyde, vanillin, permanganate, phosphomolybdic acid, iron (III) chloride, bromocresol green), o-Dianisidine bis(diazotized) zinc double salt, 2,5-Dimethoxy-4-([4-nitrophenyl]azo)benzenediazonium chloride hemi-zinc chloride salt, 5-chloro-2-methoxybenzenediazonium chloride hemi(zinc chloride) salt, (1S,2S)-2-(naphthalene-2,3-dicarboximido)cyclohexanecarboxylic acid, (1R,2R)-2-(naphthalene-2,3-dicarboximido)cyclohexanecarboxylic acid, or a suitable alternative.

The method of any one of embodiments 92-115, further comprising: adding a calibrant adjacent to but not in contact with the sample loading zone and measuring the calibrant, or measuring a calibrant added to the chromatography plate prior to running the sample, wherein the calibrant is positioned opposite of the sample loading zone and the calibrant is not contacted with either the separating and/or concentrating solvent while performing the method.

The method of embodiment 116, wherein the concentration of the analyte is determined using the calibrant as a reference standard.

The method of any one of embodiments 92-117, further comprising: before or after separating, creating a barrier by removing at least a portion of the medium from the substrate to prevent one or more of the non-analyte molecules in the mixture from traveling past the barrier in the second dimension, whereby one or more non-analyte is not concentrated in the second dimension.

The method of embodiment 118, wherein the medium is removed during manufacturing, before use, or during use.

The method of embodiment 119, wherein the medium is removed by etching, scoring, milling, or embossing.

The method of any one of embodiments 92-120, further comprising: (1) after concentrating, applying a concentrating solvent at either the first or third edge of the substrate, whereby the analyte is further concentrated.

The method of any one of embodiments 92-121, further comprising: (1) after concentrating the analyte, (i) further separating the analyte in a first dimension by applying a solvent to the first edge of the substrate; and (ii) concentrating the analyte in a second dimension by applying a concentrating solvent to the second edge of the substrate.

The method of embodiment 122, further comprising: (2) applying a concentrating solvent to either the anterior or posterior end of the first dimension of the plate.

The method of any one of embodiments 92-123, wherein the second dimension is at an angle between about 45 degrees and about 135 degrees, about 75 degrees and about 105 degrees, about 80 degrees and about 100 degrees, or about 85 degrees and about 95 degrees from the first dimension.

The method of embodiment 124, wherein the second dimension is substantially orthogonal to the first dimension.

The method of any one of embodiments 92-125, further comprising, after concentrating, heating a portion of the plate to evaporate the solvent in a third dimension, wherein the analyte is further concentrated at an evaporative front.

The method of any one of embodiments 92-126, wherein at least a portion of the solvent is removed from the substrate before applying a subsequent solvent.

The method of embodiment 127, wherein the solvent is removed by evaporation.

The method of embodiment 128, wherein the evaporation is accelerated through heating or through increased air flow.

The method of embodiment 128 or embodiment 129, further comprising preventing release of the evaporated solvent to atmosphere.

The method of embodiment 130, wherein evaporated solvent is captured using activated carbon, reduced temperature, e.g., cryogenic, increased pressure, or a suitable alternative.

The method of embodiment 130, wherein evaporated solvent is combusted.

The method of any one of embodiments 92-132, further comprising controlling the temperature of the plate.

The method of any one of embodiments 92-133, wherein at least one covering layer is in contact with and covers at least a portion of the substrate surface.

The method of any one of embodiments 92-134, wherein the concentrated analyte is extracted from the chromatography medium.

The method of any one of embodiments 92-135, performed with an article of manufacture comprising: (I) a solid substrate; and (II) chromatography medium on a surface of the substrate; wherein at least a portion of the medium is removed to expose a surface of the substrate thereby forming a barrier across which liquid phase cannot travel, and, optionally, (III) one or more calibrants placed on the chromatography medium.

The method of any one of embodiments 92-136, wherein the method is capable of detecting at least any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng and/or not more than any of any of 10 ng, 20 ng, 30 ng, 40 ng, 50 ng, 60 ng, 70 ng, 80 ng, 90 ng, 100 ng, 500 ng, 1,000 ng, 2,500 ng, 5,000 ng, or 10,000 ng of analyte per 500 uL of mixture, for example 0.1-10,000 ng of analyte per 500 uL of mixture, preferably 0.1-2,000 ng of analyte per 500 uL of mixture.

An article of manufacture comprising: (a) a solid substrate; (b) chromatography medium on the surface of the substrate through which a liquid phase can travel; (c) one or more barriers, the barrier comprising an area of substrate reduced in chromatography medium across which a liquid phase cannot travel, wherein the one or more barriers isolates a first region of chromatography medium from a second region of chromatography medium; and (d) one or more calibrants applied to the second region, whereby liquid phase applied to the first region is not able to travel to the second region and alter the one or more calibrants placed in the second region.

The article of embodiment 138, no more than any of 10, 9, 8, 7, 6, 5, 4, 3, 2, or 1 different concentrations of an analyte to be quantified using the article.

An article of manufacture comprising: (a) a solid substrate; (b) chromatography medium on the surface of the substrate through which liquid phase can travel; (c) one or more fluidic reservoirs in contact with a surface of the chromatography medium, wherein the fluidic reservoir enables application of liquid phase to the surface of the chromatography medium such that the liquid phase is able travel through the chromatography medium.

The article of embodiment 140, wherein the fluidic reservoirs are not in contact with the edge of the chromatography medium or the edge of the solid substrate and/or wherein the liquid phase does not travel on top of the surface of the chromatography medium.

A method of using the article of any one of embodiments 138-141, comprising: (a) applying a sample comprising a mixture of molecules comprising at least one analyte to a sample loading zone of a chromatography plate; (b) separating the analyte from other molecules in the mixture in a first dimension of the plate using a separating solvent; and (c) concentrating the analyte in a second dimension of the plate using a concentrating solvent.

The method of embodiment 142, wherein the concentrating solvent is applied to both sides of the analyte such that the analyte is concentrated towards the middle of the second dimension.

The method of embodiment 142 or embodiment 143, wherein the method is capable of detecting is capable of detecting at least any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng and/or not more than any of any of 10 ng, 20 ng, 30 ng, 40 ng, 50 ng, 60 ng, 70 ng, 80 ng, 90 ng, 100 ng, 500 ng, 1,000 ng, 2,500 ng, 5,000 ng, or 10,000 ng of analyte per 500 uL of mixture, for example 0.1-10,000 ng of analyte per 500 uL of mixture, preferably 0.1-2,000 ng of analyte per 500 uL of mixture.

A method comprising: (a) applying a sample comprising a mixture of molecules comprising at least one analyte to a sample loading zone of a chromatography plate, wherein the analyte is present in an amount no more than any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng; (b) separating the analyte from other molecules in the mixture in a first dimension of the plate using a separating solvent; (c) concentrating the analyte in a second dimension of the plate using a concentrating solvent; and (d) detecting the concentrated analyte.

The method of embodiment 145, wherein the sample has a volume between about 100 uL and about 1 mL, between about 250 ul and about 750 uL, or about 400 uL and about 600 uL.

The method of embodiment 145 or embodiment 146, wherein the analyte is a molecule, e.g., an organic molecule, in size up to about 50,000 Da, up to about 20,000 Da, up to about 10,000 Da, up to about 5,000 Da, up to about 2,000 Da, or up to about 1,000 Da, for example 50-50,000 Da.

A method comprising: (a) applying a sample comprising a mixture of molecules comprising at least one analyte to a sample loading zone of a chromatography plate; (b) separating the analyte from other molecules in the mixture in a first dimension of the plate using a separating solvent; and (c) concentrating the analyte in a second dimension of the plate using a concentrating solvent, wherein the concentrating solvent is applied to opposite sides of the analyte such that the analyte is compressed along the second dimension.

An apparatus comprising: (a) a solid support having a surface and chromatography medium on the surface; and (b) one or more fluidic reservoirs in contact with a surface of the chromatography medium, wherein a liquid phase applied to the fluidic reservoir is in fluid communication with the chromatography medium such that the liquid phase moves via capillary action through the chromatography medium.

The apparatus of embodiment 149, wherein the fluidic reservoirs are not in contact with the edge of the chromatography medium or the edge of the solid substrate and/or wherein the liquid phase does not travel on top of the surface of the chromatography medium.

An apparatus comprising: (a) a solid support having a surface and chromatography medium on the surface; and (b) one or more barriers comprising an area of the solid support reduced in chromatography medium across which a liquid phase cannot travel.

The apparatus of embodiment 151, comprising two barriers and a gate, the gate comprising an area of substrate where chromatography medium remains and liquid phase can travel, wherein the first barrier is in contact with a first edge of the substrate; the second barrier is in contact with a second edge of the substrate; and a gate is positioned between the first and second barriers.

The apparatus of embodiment 151 or embodiment 152, wherein the substrate has the shape of a polygon (e.g., a quadrilateral, such as a rectangle, a pentagon, or a hexagon), or curvilinear shape (e.g., a circle or an ellipse).

A method comprising: (a) providing an apparatus of any one of embodiments 151-153; (b) applying a sample and a separating solvent to a loading zone behind the first barrier; (c) separating molecules in the sample in a first direction of fluid flow, wherein the molecules pass below the barrier and through the chromatography medium; (d) applying concentrating solvent behind the second and third barriers; and (e) concentrating at least an analyte among the separated molecules along the second dimension by moving the concentrating solvents under the second barriers and towards the analyte.

The method of embodiment 154, further comprising detecting the concentrated analyte.

A method comprising: (a) applying a sample comprising a mixture of molecules comprising at least one analyte to a sample loading zone of a chromatography plate; (b) concentrating the sample in the first dimension, the second dimension, and/or both by applying a concentrating solvent to the chromatography plate; (c) separating the analyte from other molecules in the mixture in a first dimension of the plate using a separating solvent; and (d) concentrating the analyte in a second dimension of the plate using a concentrating solvent.

### EXAMPLES

### A. Example 1

A sample of 250 uL of methanol comprising a mixture of cannabinoids and other compounds comprising approximately 4 nMolar THC (i.e., 1 ng THC by mass) is loaded 5 mm away from first edge of the substrate (102) and 5 mm away from the second (104) edge of the substrate and the fourth (105) edge of the substrate while heating at about 50° C. This resulting sample band comprises an elongated region between 1 to 4 cm. THC calibrants solubilized in MeOH are then spotted about 5 mm away from the second (104) edge of the substrate and starting at least 2 cm away from the first (102) edge of the substrate with 5 mm spacing, with each spot changing in the amount weight deposited (0.5, 1, 2, 3, 4 ng) while heating. The plate is then cooled to room temperature. The plate is then run with a separating solvent (0:1 MeOH: H₂O) starting at the first (102) edge of the substrate to just under where the calibrants are spotted. The TLC plate is then heated to 100° C. for 5-10 min. The TLC plate is then run while hot with methyl-tetrahydrofuran starting at the second (104) edge of the substrate. The plate is then dried at 100° C. for 1-10 min. The plate is then dipped into a dye solution which is 1:1 water: methanol and comprises no more than 0.1% of dye by weight (4-Amino-2,5-diethoxybenzanilide diazotated zinc double salt, 4-Benzoylamino-2,5-diethoxybenzenediazonium chloride hemi(zinc chloride) salt). The plate is then allowed to sit in the dark for 15-30 min. Then detection a picture is taken using a suitable detector and densitometry measurements are made. By comparing the sample to the calibration spots a concentration can be determined.

### B. Example 2

This example demonstrates methodology for detecting an analyte in a mixture at sensitivities down to 0.1 ng per 500 uL of mixture. This methodology represents a significant advance over other thin layer chromatography methods as the combination of loading large sample volumes as well as concentrating of the analyte after separation enables unprecedented levels of sensitivity.

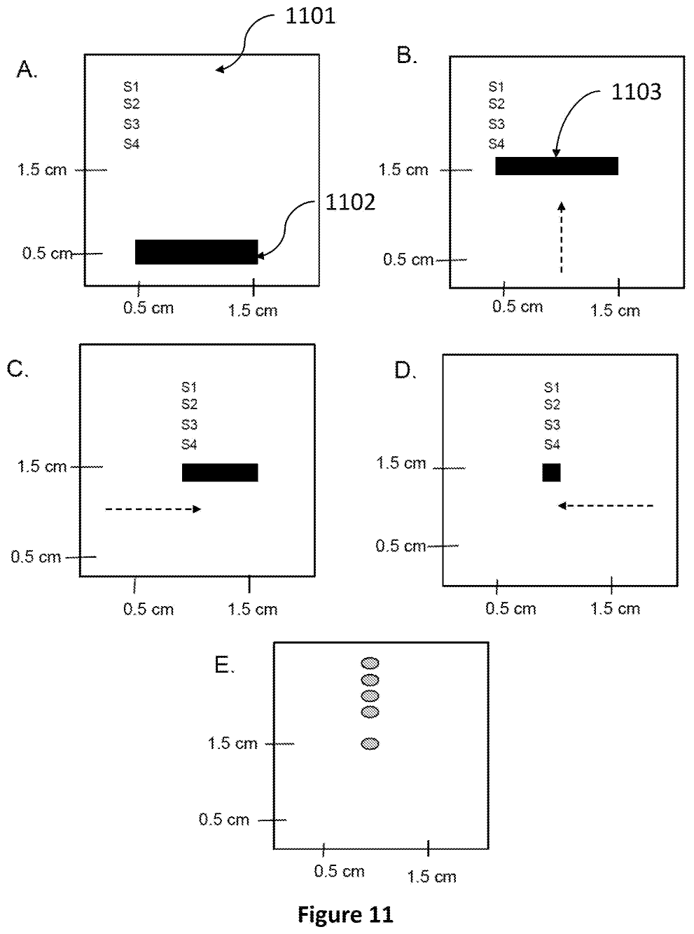

The TLC plate (1101) is pre-spotted with calibrants of the target chemical at known concentrations (S1, S2, S3, and S4 of FIG. 11A). Any suitable number of calibrants can be loaded on the TLC plate. Typically, each of the different calibrant spots are present at a different quantity for the generation of a standard curve. The TLC plate is then placed on a hot plate set to 65° C.

The sample (1102) containing the analyte of interest is spotted onto the TLC plate between two pre-marked 0.5 cm and 1.5 cm positional indicators. This step is illustrated in FIG. 11A.

Dichloromethane separating solvent is applied beneath the sample (1102) and the analyte (1103) is separated (in the direction of the dotted arrow) from the other molecules in the sample along the first dimension of the TLC plate. Separation is halted prior to the solvent front reaching the calibrants, in this case to the 1.5 cm marking. This step is illustrated in FIG. 11B. Separating solvent is then evaporated from the TLC plate (1101) by placing the TLC plate (1101) on the hotplate until the separating solvent evaporates, typically ˜10 seconds. The plate is then cooled to room temperature.

5 acetonitrile:1 water concentrating solvent is then applied to one side of the second dimension to concentrate the analyte and the standards towards the middle of the TLC plate (in the direction of the dotted arrow). This step is illustrated in FIG. 11C. Concentrating solvent is then evaporated from the TLC plate (1101) by placing the TLC plate (1101) on the hotplate until the concentrating solvent evaporates, typically ˜10 seconds. The plate is then cooled to room temperature.

5 acetonitrile:1 water concentrating solvent is then applied to the other side of the second dimension to concentrate the analyte and the standards towards the middle of the TLC plate (in the direction of the dotted arrow). This step is illustrated in FIG. 11D. Concentrating solvent is then evaporated from the TLC plate (1101) by placing the TLC plate (1101) on the hotplate until the concentrating solvent evaporates, typically ˜10 seconds. The plate is then cooled to room temperature.

0.33 mg/ml of fast blue dye in 2 methanol:1 water is then applied to the plate to stain the analyte and the standards. 1 mL of methanol is applied to the plate and a fan or compressed air is applied to push excess solvent from the plate. A picture of the plate is then captured with a camera. The image is then background subtracted and the spots comprising the analyte and the standards are separately integrated. The intensity of the analyte spot is then compared to a standard curve generated from the calibrants (a curve of intensity vs concentration) to calculate the effective amount and/or concentration of the analyte in the original sample. This step is illustrated in FIG. 11E.

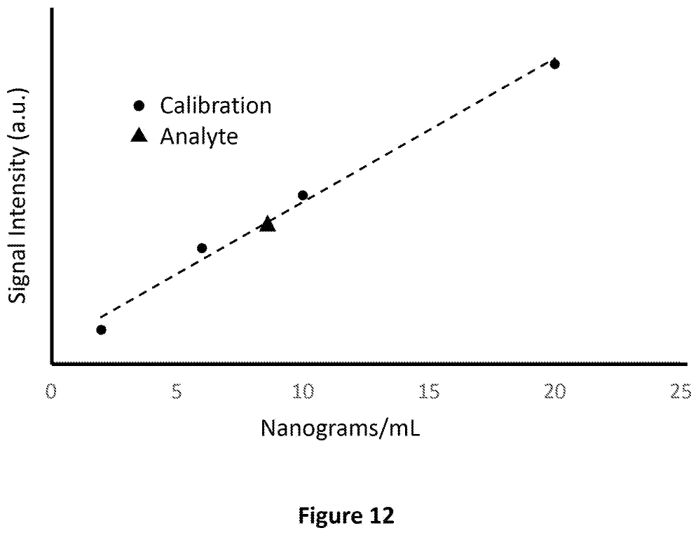

Representative data from the method is shown if FIG. 12. By using several calibration spots (2, 6, 10 and 20 ng/ml) on the same plate as an unknown sample, we are able to determine the concentration of analyte in a saliva sample. The standard curve, shown in dotted lines, has the following formula: y=1642.7x+1858.8, where y represents signal intensity from the camera image and x represents the concentration in ng/ml. Each amount of calibrant applied to the plate and their corresponding intensities are represented by circles. The analyte concentration (triangle) in the saliva sample was determined to have a concentration of 8.5 ng/ml.

### C. Example 3

This example demonstrates use of a TLC plate comprising one or more fluidic reservoirs for detecting an analyte in a mixture at sensitivities down to 0.1 ng per 500 uL of mixture. This methodology represents a significant advance over other thin layer chromatography methods as the combination of loading large sample volumes as well as concentrating of the analyte after separation enables unprecedented levels of sensitivity. Further, the use of fluidic reservoirs improves reproducibility sample processing and analyte quantification. This method and articles for performing the method are illustrated in FIG. 14.

The TLC plate (1407) is pre-spotted with calibrants of the target chemical at known concentrations in a calibrant zone (1410). The calibrant zone can be placed in any suitable position on the chromatography plate, e.g., any of the four corners of the rectangular article illustrated. The calibrant zone can be fluidically isolated from the rest of the chromatography medium via one or more barriers. Alternatively, placement of the calibrants away from solvent reservoirs (1401, 1403, 1405, and 1408) minimize their exposure to any concentrating or separating solvents during the run. Any suitable number of calibrants can be loaded on the TLC plate. Typically, each of the different calibrant spots are present at a different quantity for the generation of a standard curve. Warm air is then passed over the TLC plate to evaporate excess solvent.

The sample containing the analyte of interest is loaded into reservoir 1401 and dried. Once dry, dichloromethane separating solvent is applied to the reservoir 1401 and the analyte is separated from the other molecules in the sample along the first dimension (1402, dotted line) of the TLC plate. Separation is halted prior such that the analyte is between reservoirs 1403 and 1405 and prior to the solvent front reaching the calibrants in the case that the plate lacks a barrier surrounding the calibrants. Warm air is then passed over the TLC plate to evaporate excess solvent.

5 acetonitrile:1 water concentrating solvent is then applied to both reservoirs 1403 and 1405 simultaneously. Solvent moves through the chromatography medium along the second dimension (1404 and 1406, dotted lines) towards the center of the TLC plate. The analyte is concentrated near the middle. Warm air is then passed over the TLC plate to evaporate excess solvent. Alternatively, solvent can be applied to sequentially to reservoirs 1403 and 1405 with an optional drying step between each solvent application. Alternatively, reservoir 1405 can be omitted from the TLC plate and concentration occurs along the second dimension from a single side of the TLC plate.

0.33 mg/ml of fast blue dye in 2 methanol:1 water is then applied to reservoir 1408 and the dye travels along the first dimension (1409) until the plate is sufficiently covered with dye. The plate is dried by passing warm air over the TLC plate. 1 mL of methanol is then applied to reservoir 1408 and the solvent travels along the first dimension (1409) to solvate extra dye and a fan or compressed air is applied to push excess solvent and dye from the plate. A picture of the plate is then captured with a camera. The image is then background subtracted and the spots comprising the analyte and the standards are separately integrated. The intensity of the analyte spot is then compared to a standard curve generated from the calibrants (a curve of intensity vs concentration) to calculate the effective amount and/or concentration of the analyte in the original sample.

As used herein, the following meanings apply unless otherwise specified. The word “may” is used in a permissive sense (i.e., meaning having the potential to), rather than the mandatory sense (i.e., meaning must). The words “include”, “including”, and “includes” and the like mean including, but not limited to. The singular forms “a,” “an,” and “the” include plural referents. Thus, for example, reference to “an element” includes a combination of two or more elements, notwithstanding use of other terms and phrases for one or more elements, such as “one or more.” The phrase “at least one” includes “one”, “one or more”, “one or a plurality” and “a plurality”. The term “or” is, unless indicated otherwise, non-exclusive, i.e., encompassing both “and” and “or.” The term “any of” between a modifier and a sequence means that the modifier modifies each member of the sequence. So, for example, the phrase “at least any of 1, 2 or 3” means “at least 1, at least 2 or at least 3”. The term “about” refers to a range that is 5% plus or minus from a stated numerical value within the context of the particular usage. So, for example, “about 100” means between 95 and 105. The term “consisting essentially of” refers to the inclusion of recited elements and other elements that do not materially affect the basic and novel characteristics of a claimed combination.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials can be substituted for those illustrated and described herein, parts and processes can be reversed or omitted, and certain features of the invention can be utilized independently, all as would be apparent to one skilled in the art after having the benefit of this description of the invention. Changes can be made in the elements described herein without departing from the spirit and scope of the invention as described in the following claims. Headings used herein are for organizational purposes only and are not meant to be used to limit the scope of the description.

All publications, patents, and patent applications mentioned in this specification are herein incorporated by reference to the same extent as if each individual publication, patent, or patent application was specifically and individually indicated to be incorporated by reference.

What is claimed is:

1. A method comprising:
(a) applying a sample comprising a mixture of molecules comprising at least one analyte to a sample loading zone of a chromatography plate;
(b) separating the analyte from other molecules in the mixture in a first dimension of the plate using a separating solvent; and
(c) concentrating the analyte in a second dimension of the plate using a concentrating solvent.

2. The method of claim 1, wherein the analyte is present in the mixture at a concentration of no more than about any of 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% and/or at least about any of 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, or 0.005% weight of mixture.

3. The method of claim 1 or claim 2, wherein the analyte is present in the mixture at a concentration of at least any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng and/or not more than any of any of 10 ng, 20 ng, 30 ng, 40 ng, 50 ng, 60 ng, 70 ng, 80 ng, 90 ng, 100 ng, 500 ng, 1,000 ng, 2,500 ng, 5,000 ng, or 10,000 ng of analyte per 500 uL of mixture, for example 0.1-10,000 ng of analyte per 500 uL of mixture, preferably 0.1-2,000 ng of analyte per 500 uL of mixture.

4. The method of any one of claims 1-3, wherein the sample comprises a biological sample.

5. The method of claim 4, wherein the biological sample comprises saliva, sputum, blood, plasma, serum, urine, stool, cerebral spinal fluid, bile fluid, lymph fluid.

6. The method of any one of claims 1-3, wherein the sample comprises an environmental sample comprising a soil sample, a water sample, or an air sample.

7. The method of any one of claims 1-6, wherein the analyte comprises a controlled substance.

8. The method of claim 7, wherein the controlled substance comprises a cannabinoid.

9. The method of claim 8, wherein the cannabinoid is 10-ethoxy-9-hydroxy-delta-6a-tetrahydrocannabinol, 10-oxo-delta-6a-tetrahydrocannabinol (OTCH), 2-arachidonoylglycerol (2AG), 2-arachidonyl glyceryl ether, 8,9-dihydroxy-delta-6a-tetrahydrocannabinol, anandamide (AEA), cannabichromanon (CBCN), cannabichromene (CBC), cannabichromenevarin (CBCV), cannabichromenic Acid (CBCA), cannabichromevarinic acid (CBCVA), cannabicitran (CBT-C), cannabicyclol (CBL), cannabicyclolic acid (CBLA), cannabicyclovarin (CBLV), cannabidiol (CBD), cannabidiol monomethylether (CBDM), cannabidiolic acid (CBDA), cannabidiorcol (CBDC1), cannabidiorcol (CBN-C1), cannabidivarin (CBDV), cannabidivarinic acid (CBDVA), cannabielsoic acid A (CBEA-A), cannabielsoic acid B (CBEA-B), cannabielsoin (CBE), cannabifuran (CBF), cannabigerol (CBG), cannabigerol monomethylether (CBGM), cannabigerolic Acid (CBGA), cannabigerolic acid monomethylether (CBGAM), cannabigerovarin (CBGV), cannabigerovarinic acid (CBGVA), cannabiglendol-C3, cannabinodiol (CBND), cannabinodivarin (CBV), cannabinodivarin (CBVD), cannabinol (CBN), cannabinol methylether (CBNM), cannabinol-C2 (CBN-C2), cannabinol-C4 (CBN-C4), cannabinolic acid (CBNA), cannabiripsol (CBR), cannabitriol (CBT), cannabitriolvarin (CBTV), dehydrocannabifuran (CBFD), delta-8-tetrahydrocannabinol (Δ8-THC), delta-8-tetrahydrocannabinolic acid (Δ8-THCA), delta-9-cis-tetrahydrocannabinol (CIS-THC), delta-9-tetrahydrocannabinol (Δ9-THC), delta-9-tetrahydrocannabinol-C4 (Δ9-THC-C4), delta-9-tetrahydrocannabinolic acid A (Δ9-THCA-A), delta-9-tetrahydrocannabinolic acid B (Δ9-THCA-B), delta-9-tetrahydrocannabinolic acid C4 (Δ9-THCA-C4), delta-9-tetrahydrocannabiorcol (Δ9-THCA-C1), delta-9-tetrahydrocannabiorolic acid C1 (Δ9-THCA-C1), delta-9-tetrahydrocannabivarin (THCV), delta-9-tetrahydrocannabivarinic acid (THCVA), lysophosphatidylinositol (LPI), N-arachidonoyl dopamine (NADA), tetrahydrocannabinol (THC), trihydroxy-delta-9-tetrahydrocannabinol (TRIOH-THC), virodhamine (OAE), or a variant thereof.

10. The method of any one of claims 1-9, wherein the chromatography plate comprises:
(i) a solid substrate comprising a surface and four edges, wherein a first edge is opposite to a third edge and a second edge is opposite to a fourth edge;
(ii) a chromatography medium on the substrate;
(iii) a separation zone oriented along the first dimension of the plate, wherein the first dimension is directed between the first and the third edge of the substrate;
(iv) a concentration zone oriented along the second dimension of the plate, wherein the second dimension is directed between the second and fourth edge of the substrate; and
(v) a sample loading zone positioned near the anterior end of the first and second dimensions adjacent to the first and second edge of the substrate.

11. The method of any one of claims 1-10, wherein the sample loading zone has a capacity between about 1 uL and about 2 mL, preferably about 100 uL to about 1 mL, more preferably about 250 uL to about 750 uL, even more preferably about 400 uL to about 600 uL.

12. The method of any one of claims 1-11, wherein the sample loading zone has an elongated shape comprising a long axis between about 2.5 and about 50 mm long.

13. The method of any one of claims 1-12, wherein, after separating, the analyte is separated from at least 50% of the non-analyte molecules in the mixture.

14. The method of any one of claims 1-13, wherein the analyte is concentrated to an area to an area of less than about any of 50%, 45%, 40%, 35%, 30%, 25%, 20%, 15%, 10%, 5%, 1%, 0.5%, or 0.1% of the sample loading zone.

15. The method of any one of claims 1-14, wherein the sample loading zone comprises a separate chromatography medium from the separating zone and the concentrating zone whereby the sample concentrates at the boundary between the two mediums.

16. The method of any one of claims 1-15, wherein the first dimension is between about 0.5 cm to about 10 cm long.

17. The method of any one of claims 1-16, wherein the separating solvent comprises any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

18. The method of any one of claims 1-17, wherein the concentrating solvent comprises of any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

19. The method of any one of claims 1-18, further comprising:
d) detecting the analyte.

20. The method of claim 19, wherein detecting the analyte comprises measuring at least one optical property of the analyte.

21. The method of claim 20, wherein the optical property is absorbance, fluorescence, reflectance, or optical rotation.

22. The method of any one of claims 19-21, wherein detecting the analyte comprises taking one or more images of the chromatography plate with a detector, preferably a camera.

23. The method of any one of claims 1-22, further comprising, after concentrating, applying an indicator, e.g., dye, to the chromatography medium.

24. The method of claim 23, wherein the indicator comprises of any one of iodine, p-anisaldehyde, vanillin, permanganate, phosphomolybdic acid, iron (III) chloride, bromocresol green), o-Dianisidine bis (diazotized) zinc double salt, 2,5-Dimethoxy-4-([4-nitrophenyl]azo)benzenediazonium chloride hemi-zinc chloride salt, 5-chloro-2-methoxybenzenediazonium chloride hemi(zinc chloride) salt, (1S,2S)-2-(naphthalene-2,3-dicarboximido)cyclohexanecarboxylic acid, (1R,2R)-2-(naphthalene-2,3-dicarboximido)cyclohexanecarboxylic acid, or a suitable alternative.

25. The method of any one of claims 1-24, further comprising:
adding a calibrant adjacent to but not in contact with the sample loading zone and measuring the calibrant, wherein the calibrant separates along the first dimension after applying the separating solvent, or
measuring a calibrant added to the chromatography plate prior to running the sample, wherein the calibrant is positioned opposite of the sample loading zone and the calibrant is not contacted with either the separating and/or concentrating solvent while performing the method.

26. The method of claim 25, wherein the concentration of the analyte is determined using the calibrant as a reference standard.

27. The method of any one of claims 1-26, further comprising:
before or after separating, creating a barrier by removing at least a portion of the medium from the substrate to prevent one or more of the non-analyte molecules in the mixture from traveling past the barrier in the second dimension, whereby one or more non-analyte is not concentrated in the second dimension.

28. The method of claim 27, wherein the medium is removed during manufacturing of the plate, before use, or during use.

29. The method of claim 28, wherein the medium is removed by etching, scoring, milling, or embossing.

30. The method of any one of claims 1-29, further comprising:
(1) after concentrating, applying a concentrating solvent at either the first or third edge of the substrate, whereby the analyte is further concentrated.

31. The method of any one of claims 1-30, further comprising:
(1) after concentrating the analyte,
(i) further separating the analyte in a first dimension by applying a solvent to the first edge of the substrate; and
(ii) concentrating the analyte in a second dimension by applying a concentrating solvent to the second edge of the substrate.

32. The method of claim 31, further comprising:
(2) applying a concentrating solvent to either the anterior or posterior end of the first dimension of the plate.

33. The method of any one of claims 1-32, wherein the second dimension is at an angle between about 45 degrees and about 135 degrees, about 75 degrees and about 105 degrees, about 80 degrees and about 100 degrees, or about 85 degrees and about 95 degrees from the first dimension.

34. The method of claim 33, wherein the second dimension is substantially orthogonal to the first dimension.

35. The method of any one of claims 1-34, further comprising, after concentrating, heating a portion of the plate to evaporate the solvent in a third dimension, wherein the analyte is further concentrated at an evaporative front.

36. The method of any one of claims 1-35, wherein at least a portion of the solvent is removed from the substrate before applying a subsequent solvent.

37. The method of claim 36, wherein the solvent is removed by evaporation.

38. The method of claim 37, wherein the evaporation is accelerated through heating or through increased air flow.

39. The method of claim 37 or claim 38, further comprising preventing release of the evaporated solvent to atmosphere.

40. The method of claim 39, wherein evaporated solvent is captured using activated carbon, reduced temperature, e.g., cryogenic, increased pressure, or a suitable alternative.

41. The method of claim 39, wherein evaporated solvent is combusted.

42. The method of any one of claims 1-41, further comprising controlling the temperature of the plate.

43. The method of any one of claims 1-42, wherein at least one covering layer is in contact with and covers at least a portion of the substrate surface.

44. The method of any one of claims 1-43, wherein the concentrated analyte is extracted from the chromatography medium.

45. The method of any one of claims 1-44, performed with an article of manufacture comprising:
(I) a solid substrate; and
(II) chromatography medium on a surface of the substrate;
wherein at least a portion of the medium is removed to expose a surface of the substrate thereby forming a barrier across which liquid phase cannot travel, and, optionally,
(III) one or more calibrants placed on the chromatography medium.

46. The method of any one of claims 1-45, wherein the method is capable of detecting at least any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng and/or not more than any of any of 10 ng, 20 ng, 30 ng, 40 ng, 50 ng, 60 ng, 70 ng, 80 ng, 90 ng, 100 ng, 500 ng, 1,000 ng, 2,500 ng, 5,000 ng, or 10,000 ng of analyte per 500 uL of mixture, for example 0.1-10,000 ng of analyte per 500 uL of mixture, preferably 0.1-2,000 ng of analyte per 500 uL of mixture.

47. An article of manufacture comprising:
(a) a solid substrate comprising a surface and four edges, wherein a first edge is opposite to a third edge and a second edge is opposite to a fourth edge;
(b) chromatography medium on the surface of the substrate through which liquid phase can travel; and
(c) one or more barriers, the barrier comprising an area of substrate reduced in chromatography medium across which a liquid phase cannot travel.

48. The article of claim 46, wherein the one or more barriers span at least a portion of the length between the first to the third edge of the substrate.

49. The article of claim 47 or claim 48, wherein the barrier is offset from the second or fourth edge of the substrate by at least 1 cm.

50. The article of any one of claims 47-49, comprising two barriers and a gate, the gate comprising an area of substrate where chromatography medium remains and liquid phase can travel, wherein
the first barrier is in contact with the first edge of the substrate;
the second barrier is in contact with the third edge of the substrate; and
a gate is positioned between the first and second barrier.

51. The article of any one of claims 47-50, wherein at least a portion of the chromatography medium is surrounded by a barrier resulting in two fluidically isolated areas of chromatography medium, optionally, wherein one or more calibrants is place in one of the fluidically isolated areas of the chromatography medium.

52. The article of claim 51, further comprising a second barrier thereby resulting in three fluidically isolated areas of chromatography medium.

53. The article of claim 52, further comprising three fluidically isolated areas of chromatography medium wherein
the first barrier extends from the end of the first barrier opposite the first edge of the substrate to either the second or fourth edge of the substrate; and
the second barrier extends from the end of the second barrier opposite the third edge of the substrate to either the second or fourth edge of the substrate.

54. The article of any one of claims 47-53, wherein the substrate comprises any one of glass, quartz, metal, aluminum, and plastic.

55. The article of any one of claims 47-54, wherein the substrate is at least 2.5 by 2.5 mm.

56. The article of any one of claims 47-55, wherein the chromatography medium comprises any one of silica, alumina, cellulose, or polyamide.

57. The article of any one of claims 47-56, wherein the chromatography medium comprises one or more C2, C8, C10, C18, phenol, amine, or chiral chemical modifications.

58. The article of any one of claims 47-57, wherein the chromatography medium further comprises a fluorescent molecule whereby the chromatography medium fluoresces upon exposure to electromagnetic radiation.

59. The article of any one of claims 47-58, wherein the article comprises:
(i) a separation zone oriented along a first dimension of the substrate, wherein the first dimension is directed between the first and third edge of the substrate;
(ii) a concentration zone oriented along a second dimension of the substrate, wherein the second dimension is directed between the second and fourth edge of the substrate; and
(iii) a sample loading zone positioned near the anterior end of the first and second dimensions adjacent to the first and second edge of the substrate.

60. The article of claim 59, wherein the separation zone is at least 2.5 cm long.

61. The article of claim 59, wherein the separation zone is no more than 99% of the substrate length.

62. The article of claim 59, wherein the separation zone comprises two or more subzones, wherein each subzone comprises a different chromatography medium.

63. The article of claim 59, wherein the sample loading zone comprises an elongated shape.

64. The article of claim 63, wherein the elongated sample loading zone comprises a short axis oriented along the first dimension of the substrate and a long axis oriented along the second dimension of the substrate.

65. The article of claim 64, where the long axis of the sample loading zone is about 10 times as long as the short axis of the sample loading zone.

66. The article of claim 59, wherein the sample loading zone comprises at most 40% of the height and 95% of the width of the substrate.

67. The article of claim 59, wherein the sample loading zone comprises a separate chromatography medium from the separating zone and the concentrating zone whereby the sample concentrates at the boundary between the two mediums.

68. The article of any one of claims 47-67, further comprising a covering layer in contact with at least a portion of the chromatography medium.

69. The article of claim 68, wherein the covering layer comprises any one of glass, quartz, metal, epoxy, or plastic.

70. A method of making an article of any one of claims 47-69, comprising:
(a) obtaining a substrate;
(b) coating the substrate with chromatography medium; and
(c) removing at least a portion of chromatography medium from the substrate, thereby forming a barrier free of chromatography medium across which a liquid phase cannot travel.

71. The method of claim 70, wherein the chromatography medium is removed by etching, scoring, milling, or embossing.

72. The method of claim 70 or claim 71, further comprising a calibrant adjacent to but not in contact with the sample loading zone.

73. A method of making an article of any one of claims 47-69, comprising:
(a) obtaining a substrate;
(b) masking at least a portion of the substrate;
(c) coating the substrate with chromatography medium; and
(d) removing the mask and any coated chromatography medium, thereby forming a barrier free of chromatography medium across which a liquid phase cannot travel.

74. The method of claim 73, further comprising a calibrant adjacent to but not in contact with the sample loading zone.

75. A kit comprising:
(a) an article of any one of claims 47-69; and
(b) at least one solvent, preferably two solvents.

76. The kit of claim 75, wherein the solvent comprises any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

77. The kit of claim 75 or claim 76, further comprising:
(c) an indicator, e.g., dye.

78. The kit of claim 75, where in the indicator comprises of any one of iodine, p-anisaldehyde, vanillin, permanganate, phosphomolybdic acid, iron (III) chloride, bromocresol green), o-Dianisidine bis (diazotized) zinc double salt, 2,5-Dimethoxy-4-([4-nitrophenyl]azo)benzenediazonium chloride hemi-zinc chloride salt, 5-chloro-2-methoxybenzenediazonium chloride hemi(zinc chloride) salt, (1S,2S)-2-(naphthalene-2,3-dicarboximido)cyclohexanecarboxylic acid, (1R,2R)-2-(naphthalene-2,3-dicarboximido)cyclohexanecarboxylic acid, or a suitable alternative.

79. A system comprising:
(a) a receiving area for a chromatography plate;
(b) at least one solvent chamber configured such that, when the chromatography cartridge is inserted into the receiving area, the solvent chamber is in fluid communication with at least a portion of the chromatography medium, optionally, wherein the solvent chamber is in fluid communication with one or more sources of solvent; and
(c) a detector.

80. The system of claim 79, wherein the receiving area is oriented horizontally.

81. The system of claim 79, wherein the receiving is oriented vertically.

82. The system of any one of claims 79-81, wherein the chromatography plate comprises an article of claim 47-69.

83. The system of any one of claims 79-82, wherein the system is configured to receive the chromatography plate.

84. The system of claim 79-83, wherein the solvent chamber comprises a material comprising any one of glass, metal, PTFE, PVDF, ECTFE, PCTFE, FEP, ETFE, PEEK, PPS, or a suitable alternative.

85. The system of claim 79-84, wherein the solvent chamber comprises a sealing element to reduce solvent evaporation.

86. The system of claim 85, wherein the sealing element can be removed and reattached or replaced to allow solvent additions.

87. The system of any one of claims 79-86, wherein the detector is an optical detector, preferably a camera configured to image at least any of 25%, 30%, 35%, 40%, 45%, 50%, 55%, 60%, 65%, 70%, 65%, 80%, 85%, 90%, 95%, or 100% of the surface area of the chromatography plate, preferably 25-75%, more preferably 40-60%.

88. The system of any one of claims 79-87, further comprising a covering layer that when in contact with the receiving area produces a sealed chamber.

89. The system of any one of claims 79-88, further comprising a temperature control element.

90. The system of any one of claims 79-89, further comprising a component to accelerate evaporation of solvent from the chromatography medium, e.g., a fan, a source of compress air, and/or a heater element, configured accelerate the rate of evaporation, wherein the component is configured to activate after a sample loading step, a separation step, a concentration step, and/or a indicator application step.

91. A kit comprising:
(a) an article of any one of claims 47-69; and
(b) a system of any one of claims 79-90.

92. A method comprising:
(a) applying a sample comprising a mixture of molecules comprising at least one analyte to a sample loading zone of a chromatography plate;
(b) separating the analyte from other molecules in the mixture in a first dimension of the plate using a separating solvent; and
(c) concentrating the analyte in a second dimension of the plate using a concentrating solvent, wherein the concentrating solvent is applied to both sides of the analyte such that the analyte is concentrated towards the middle of the second dimension.

93. The method of claim 92, wherein the analyte is present in the mixture at a concentration of no more than about any of 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% and/or at least about any of 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, or 0.005% weight of mixture.

94. The method of claim 92 or claim 93, wherein the analyte is present in the mixture at a concentrate of no more than about any of 1 ng, 0.9 ng, 0.8 ng, 0.7 ng, 0.6 ng, 0.5 ng, 0.4 ng, 0.3 ng, 0.2 ng, 0.1 ng, 0.09 ng, 0.08 ng, 0.07 ng, 0.06 ng, 0.05 ng, 0.04 ng, 0.03 ng, 0.02 ng, or 0.01 ng, or 0.005 ng and/or at least about any of 0.9 ng, 0.8 ng, 0.7 ng, 0.6 ng, 0.5 ng, 0.4 ng, 0.3 ng, 0.2 ng, 0.1 ng, 0.09 ng, 0.08 ng, 0.07 ng, 0.06 ng, 0.05 ng, 0.04 ng, 0.03 ng, 0.02 ng, 0.01 ng, 0.005 ng, or 0.001 ng per 500 uL.

95. The method of any one of claims 92-94, wherein the sample comprises a biological sample.

96. The method of claim 95, wherein the biological sample comprises saliva, sputum, blood, plasma, serum, urine, stool, cerebral spinal fluid, bile fluid, lymph fluid.

97. The method of any one of claims 92-94, wherein the sample comprises an environmental sample comprising a soil sample, a water sample, or an air sample.

98. The method of any one of claims 92-97, wherein the analyte comprises a controlled substance.

99. The method of claim 98, wherein the controlled substance comprises a cannabinoid.

100. The method of claim 99, wherein the cannabinoid is 10-ethoxy-9-hydroxy-delta-6a-tetrahydrocannabinol, 10-oxo-delta-6a-tetrahydrocannabinol (OTCH), 2-arachidonoylglycerol (2AG), 2-arachidonyl glyceryl ether, 8,9-dihydroxy-delta-6a-tetrahydrocannabinol, anandamide (AEA), cannabichromanon (CBCN), cannabichromene (CBC), cannabichromenevarin (CBCV), cannabichromenic Acid (CBCA), cannabichromevarinic acid (CBCVA), cannabicitran (CBT-C), cannabicyclol (CBL), cannabicyclolic acid (CBLA), cannabicyclovarin (CBLV), cannabidiol (CBD), cannabidiol monomethylether (CBDM), cannabidiolic acid (CBDA), cannabidiorcol (CBDC1), cannabidiorcol (CBN-C1), cannabidivarin (CBDV), cannabidivarinic acid (CBDVA), cannabielsoic acid A (CBEA-A), cannabielsoic acid B (CBEA-B), cannabielsoin (CBE), cannabifuran (CBF), cannabigerol (CBG), cannabigerol monomethylether (CBGM), cannabigerolic Acid (CBGA), cannabigerolic acid monomethylether (CBGAM), cannabigerovarin (CBGV), cannabigerovarinic acid (CBGVA), cannabiglendol-C3, cannabinodiol (CBND), cannabinodivarin (CBV), cannabinodivarin (CBVD), cannabinol (CBN), cannabinol methylether (CBNM), cannabinol-C2 (CBN-C2), cannabinol-C4 (CBN-C4), cannabinolic acid (CBNA), cannabiripsol (CBR), cannabitriol (CBT), cannabitriolvarin (CBTV), dehydrocannabifuran (CBFD), delta-8-tetrahydrocannabinol (Δ8-THC), delta-8-tetrahydrocannabinolic acid (Δ8-THCA), delta-9-cis-tetrahydrocannabinol (CIS-THC), delta-9-tetrahydrocannabinol (Δ9-THC), delta-9-tetrahydrocannabinol-C4 (Δ9-THC-C4), delta-9-tetrahydrocannabinolic acid A (Δ9-THCA-A), delta-9-tetrahydrocannabinolic acid B (Δ9-THCA-B), delta-9-tetrahydrocannabinolic acid C4 (Δ9-THCA-C4), delta-9-tetrahydrocannabiorcol (Δ9-THCA-C1), delta-9-tetrahydrocannabiorolic acid C1 (Δ9-THCA-C1), delta-9-tetrahydrocannabivarin (THCV), delta-9-tetrahydrocannabivarinic acid (THCVA), lysophosphatidylinositol (LPI), N-arachidonoyl dopamine (NADA), tetrahydrocannabinol (THC), trihydroxy-delta-9-tetrahydrocannabinol (TRIOH-THC), virodhamine (OAE), or a variant thereof.

101. The method of any one of claims 92-100, wherein the chromatography plate comprises:
(i) a solid substrate comprising a surface and four edges, wherein a first edge is opposite to a third edge and a second edge is opposite to a fourth edge;
(ii) a chromatography medium on the substrate;
(iii) a separation zone oriented along the first dimension of the plate, wherein the first dimension is directed between the first and the third edge of the substrate; and
(iv) a concentration zone oriented along the second dimension of the plate, wherein the second dimension is directed between the second and fourth edge of the substrate; and
(v) a sample loading zone positioned near the anterior end of the first and second dimensions adjacent to the first and second edge of the substrate.

102. The method of any one of claims 92-101, wherein the sample loading zone has a capacity between about 1 uL and about 2 mL, preferably about 100 uL to about 1 mL, more preferably about 250 uL to about 750 uL, even more preferably about 400 uL to about 600 uL.

103. The method of any one of claims 92-102, wherein the sample loading zone has an elongated shape comprising a long axis between about 2.5 and about 50 mm long.

104. The method of any one of claims 92-103, wherein, after separating, the analyte is separated from at least 50% of the non-analyte molecules in the mixture.

105. The method of any one of claims 92-104, wherein the analyte is concentrated to an area to an area of less than about any of 50%, 45%, 40%, 35%, 30%, 25%, 20%, 15%, 10%, 5%, 1%, 0.5%, or 0.1% of the sample loading zone.

106. The method of any one of claims 92-105, wherein the sample loading zone comprises a separate chromatography medium from the separating zone and the concentrating zone whereby the sample concentrates at the boundary between the two mediums.

107. The method of any one of claims 92-106, wherein the first dimension is between about 0.5 cm to about 10 cm long.

108. The method of any one of claims 92-107, wherein the separating solvent comprises any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

109. The method of any one of claims 92-108, wherein the concentrating solvent comprises of any one of dichloromethane, acetonitrile, methanol, methyl tert-butyl ether, tetrahydrofuran, hexane, toluene, benzene, dimethyl sulfoxide, dimethylformamide, water, ionic liquid, or any mix thereof.

110. The method of any one of claims 92-109, further comprising:
(d) detecting the analyte.

111. The method of claim 110, wherein detecting the analyte comprises measuring at least one optical property of the analyte.

112. The method of claim 111, wherein the optical property is absorbance, fluorescence, reflectance, or optical rotation.

113. The method of any one of claims 110-112, wherein detecting the analyte comprises taking one or more images of the chromatography plate with a detector, preferably a camera.

114. The method of any one of claims 92-113, further comprising, after concentrating, applying an indicator, e.g., dye, to the chromatography medium.

115. The method of claim 114, wherein the indicator comprises of any one of iodine, p-anisaldehyde, vanillin, permanganate, phosphomolybdic acid, iron (III) chloride, bromocresol green), o-Dianisidine bis (diazotized) zinc double salt, 2,5-Dimethoxy-4-([4-nitrophenyl]azo)benzenediazonium chloride hemi-zinc chloride salt, 5-chloro-2-methoxybenzenediazonium chloride hemi(zinc chloride) salt, (1S,2S)-2-(naphthalene-2,3-dicarboximido)cyclohexanecarboxylic acid, (1R,2R)-2-(naphthalene-2,3-dicarboximido)cyclohexanecarboxylic acid, or a suitable alternative.

116. The method of any one of claims 92-115, further comprising:
adding a calibrant adjacent to but not in contact with the sample loading zone and measuring the calibrant, or
measuring a calibrant added to the chromatography plate prior to running the sample, wherein the calibrant is positioned opposite of the sample loading zone and the calibrant is not contacted with either the separating and/or concentrating solvent while performing the method.

117. The method of claim 116, wherein the concentration of the analyte is determined using the calibrant as a reference standard.

118. The method of any one of claims 92-117, further comprising:
before or after separating, creating a barrier by removing at least a portion of the medium from the substrate to prevent one or more of the non-analyte molecules in the mixture from traveling past the barrier in the second dimension, whereby one or more non-analyte is not concentrated in the second dimension.

119. The method of claim 118, wherein the medium is removed during manufacturing, before use, or during use.

120. The method of claim 119, wherein the medium is removed by etching, scoring, milling, or embossing.

121. The method of any one of claims 92-120, further comprising:
(1) after concentrating, applying a concentrating solvent at either the first or third edge of the substrate, whereby the analyte is further concentrated.

122. The method of any one of claims 92-121, further comprising:
(1) after concentrating the analyte,
(i) further separating the analyte in a first dimension by applying a solvent to the first edge of the substrate; and
(ii) concentrating the analyte in a second dimension by applying a concentrating solvent to the second edge of the substrate.

123. The method of claim 122, further comprising:
(2) applying a concentrating solvent to either the anterior or posterior end of the first dimension of the plate.

124. The method of any one of claims 92-123, wherein the second dimension is at an angle between about 45 degrees and about 135 degrees, about 75 degrees and about 105 degrees, about 80 degrees and about 100 degrees, or about 85 degrees and about 95 degrees from the first dimension.

125. The method of claim 124, wherein the second dimension is substantially orthogonal to the first dimension.

126. The method of any one of claims 92-125, further comprising, after concentrating, heating a portion of the plate to evaporate the solvent in a third dimension, wherein the analyte is further concentrated at an evaporative front.

127. The method of any one of claims 92-126, wherein at least a portion of the solvent is removed from the substrate before applying a subsequent solvent.

128. The method of claim 127, wherein the solvent is removed by evaporation.

129. The method of claim 128, wherein the evaporation is accelerated through heating or through increased air flow.

130. The method of claim 128 or claim 129, further comprising preventing release of the evaporated solvent to atmosphere.

131. The method of claim 130, wherein evaporated solvent is captured using activated carbon, reduced temperature, e.g., cryogenic, increased pressure, or a suitable alternative.

132. The method of claim 130, wherein evaporated solvent is combusted.

133. The method of any one of claims 92-132, further comprising controlling the temperature of the plate.

134. The method of any one of claims 92-133, wherein at least one covering layer is in contact with and covers at least a portion of the substrate surface.

135. The method of any one of claims 92-134, wherein the concentrated analyte is extracted from the chromatography medium.

136. The method of any one of claims 92-135, performed with an article of manufacture comprising:
(I) a solid substrate; and
(II) chromatography medium on a surface of the substrate;
wherein at least a portion of the medium is removed to expose a surface of the substrate thereby forming a barrier across which liquid phase cannot travel, and, optionally,
(III) one or more calibrants placed on the chromatography medium.

137. The method of any one of claims 92-136, wherein the method is capable of detecting at least any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng and/or not more than any of any of 10 ng, 20 ng, 30 ng, 40 ng, 50 ng, 60 ng, 70 ng, 80 ng, 90 ng, 100 ng, 500 ng, 1,000 ng, 2,500 ng, 5,000 ng, or 10,000 ng of analyte per 500 uL of mixture, for example 0.1-10,000 ng of analyte per 500 uL of mixture, preferably 0.1-2,000 ng of analyte per 500 uL of mixture.

138. An article of manufacture comprising:
(a) a solid substrate;
(b) chromatography medium on the surface of the substrate through which a liquid phase can travel;
(c) one or more barriers, the barrier comprising an area of substrate reduced in chromatography medium across which a liquid phase cannot travel, wherein the one or more barriers isolates a first region of chromatography medium from a second region of chromatography medium; and
(d) one or more calibrants applied to the second region, whereby liquid phase applied to the first region is not able to travel to the second region and alter the one or more calibrants placed in the second region.

139. The article of claim 138, no more than any of 10, 9, 8, 7, 6, 5, 4, 3, 2, or 1 different concentrations of an analyte to be quantified using the article.

140. An article of manufacture comprising:
(a) a solid substrate;
(b) chromatography medium on the surface of the substrate through which liquid phase can travel;
(c) one or more fluidic reservoirs in contact with a surface of the chromatography medium, wherein the fluidic reservoir enables application of liquid phase to the surface of the chromatography medium such that the liquid phase is able travel through the chromatography medium.

141. The article of claim 140, wherein the fluidic reservoirs are not in contact with the edge of the chromatography medium or the edge of the solid substrate and/or wherein the liquid phase does not travel on top of the surface of the chromatography medium.

142. A method of using the article of any one of claims 138-141, comprising:
(a) applying a sample comprising a mixture of molecules comprising at least one analyte to a sample loading zone of a chromatography plate;
(b) separating the analyte from other molecules in the mixture in a first dimension of the plate using a separating solvent; and
(c) concentrating the analyte in a second dimension of the plate using a concentrating solvent.

143. The method of claim 142, wherein the concentrating solvent is applied to both sides of the analyte such that the analyte is concentrated towards the middle of the second dimension.

144. The method of claim 142 or claim 143, wherein the method is capable of detecting is capable of detecting at least any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng and/or not more than any of any of 10 ng, 20 ng, 30 ng, 40 ng, 50 ng, 60 ng, 70 ng, 80 ng, 90 ng, 100 ng, 500 ng, 1,000 ng, 2,500 ng, 5,000 ng, or 10,000 ng of analyte per 500 uL of mixture, for example 0.1-10,000 ng of analyte per 500 uL of mixture, preferably 0.1-2,000 ng of analyte per 500 uL of mixture.

145. A method comprising:
(a) applying a sample comprising a mixture of molecules comprising at least one analyte to a sample loading zone of a chromatography plate, wherein the analyte is present in an amount no more than any of 0.1 ng, 0.2 ng, 0.3 ng, 0.4 ng, 0.5 ng, 0.6 ng, 0.7 ng, 0.8 ng, 0.9 ng, 1 ng, 5 ng, 10 ng, 25 ng, 50 ng, or 100 ng;
(b) separating the analyte from other molecules in the mixture in a first dimension of the plate using a separating solvent;
(c) concentrating the analyte in a second dimension of the plate using a concentrating solvent; and
(d) detecting the concentrated analyte.

146. The method of claim 145, wherein the sample has a volume between about 100 ul and about 1 mL, between about 250 uL and about 750 uL, or about 400 ul and about 600 uL.

147. The method of claim 145 or claim 146, wherein the analyte is a molecule, e.g., an organic molecule, in size up to about 50,000 Da, up to about 20,000 Da, up to about 10,000 Da, up to about 5,000 Da, up to about 2,000 Da, or up to about 1,000 Da, for example 50-50,000 Da.

148. A method comprising:
(a) applying a sample comprising a mixture of molecules comprising at least one analyte to a sample loading zone of a chromatography plate;
(b) separating the analyte from other molecules in the mixture in a first dimension of the plate using a separating solvent; and
(c) concentrating the analyte in a second dimension of the plate using a concentrating solvent, wherein the concentrating solvent is applied to opposite sides of the analyte such that the analyte is compressed along the second dimension.

149. An apparatus comprising:
(a) a solid support having a surface and chromatography medium on the surface; and
(b) one or more fluidic reservoirs in contact with a surface of the chromatography medium, wherein a liquid phase applied to the fluidic reservoir is in fluid communication with the chromatography medium such that the liquid phase moves via capillary action through the chromatography medium.

150. The apparatus of claim 149, wherein the fluidic reservoirs are not in contact with the edge of the chromatography medium or the edge of the solid substrate and/or wherein the liquid phase does not travel on top of the surface of the chromatography medium.

151. An apparatus comprising:
(a) a solid support having a surface and chromatography medium on the surface; and
(b) one or more barriers comprising an area of the solid support reduced in chromatography medium across which a liquid phase cannot travel.

152. The apparatus of claim 151, comprising two barriers and a gate, the gate comprising an area of substrate where chromatography medium remains and liquid phase can travel, wherein
the first barrier is in contact with a first edge of the substrate;
the second barrier is in contact with a second edge of the substrate; and
a gate is positioned between the first and second barriers.

153. The apparatus of claim 151 or claim 152, wherein the substrate has the shape of a polygon (e.g., a quadrilateral, such as a rectangle, a pentagon or a hexagon), or curvilinear shape (e.g., a circle or an ellipse).

154. A method comprising:
(a) providing an apparatus of any one of claims 151-153;
(b) applying a sample and a separating solvent to a loading zone behind the first barrier;
(c) separating molecules in the sample in a first direction of fluid flow, wherein the molecules pass below the barrier and through the chromatography medium;
(d) applying concentrating solvent behind the second and third barriers; and
(e) concentrating at least an analyte among the separated molecules along the second dimension by moving the concentrating solvents under the second barriers and towards the analyte.

155. The method of claim 154, further comprising detecting the concentrated analyte.

156. A method comprising:
(a) applying a sample comprising a mixture of molecules comprising at least one analyte to a sample loading zone of a chromatography plate;
(b) concentrating the sample in the first dimension, the second dimension, and/or both by applying a concentrating solvent to the chromatography plate;
(c) separating the analyte from other molecules in the mixture in a first dimension of the plate using a separating solvent; and
(d) concentrating the analyte in a second dimension of the plate using a concentrating solvent.
